(19) United States
(12) Patent Application Publication
(10) Pub. No.: US 2008/0250057 A1
(43) Pub. Date: Oct. 9, 2008

(54) Data Table Management System and Methods Useful Therefor

(76) Inventors: Russell I. Rothstein, Potomac, MD (US); Izack Varsanno, Rishon Lezion (IL)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(21) Appl. No.: 12/088,174

(22) PCT Filed: Sep. 26, 2006
(86) PCT No.: PCT/IL06/01121

§ 371 Date: Mar. 26, 2008

Related U.S. Application Data
(60) Provisional application No. 60/720,459, filed on Sep. 27, 2005.

(51) Int. Cl. G06F 17/30; G06F 7/08

(52) U.S. Cl. 707/102; 707/E17.009

(57) ABSTRACT

A data table management system operative to manage at least one data table storing a multiplicity of data elements such as data records, the system comprising a data element usage monitor operative to record information pertaining to usage of individual elements in at least one data table; and a data element evaluator operative to evaluate the importance of data elements as a function of the information pertaining to usage thereof recorded by the data element usage monitor. The system and methods are described in the context of a relational data base and a RDBMS data warehouse merely by way of example. The systems and methods described including those pertaining to fine-grained monitoring and usage-based analysis are also applicable to other structured data management systems such as but not limited to as object-oriented databases including XML-oriented databases and distributed systems based on the XQuery framework.

### REFERENCE TO CO-PENDING APPLICATIONS

The present application claims priority from copending U.S. provisional application No. 60/720,459, entitled Prioritization Server, and filed Sep. 27, 2005.

### FIELD OF THE INVENTION

The present invention relates generally to data management and specifically to management of data tables.

### BACKGROUND OF THE INVENTION

Many data management systems are known, such as, for example, U.S. Pat. No. 5,870,746 to Knutson et al.

The disclosures of any publications mentioned in the specifications, and of the publications cited therein directly or indirectly, are hereby incorporated by reference.

### SUMMARY OF THE INVENTION

The present invention seeks to provide improved systems and methods for data table management.

There is thus provided, in accordance with a preferred embodiment of the present invention, a data table management system operative to manage at least one data table storing a multiplicity of data records, the system comprising a data element usage monitor operative to record information pertaining to usage of individual elements in said at least one data table; and a data element evaluator operative to evaluate the importance of data elements as a function of the information pertaining to usage thereof recorded by the data element usage monitor.

Also provided, in accordance with another preferred embodiment of the present invention, is data repository apparatus operative in conjunction with at least one data table storing a multiplicity of data records, the data repository apparatus comprising a representation of information pertaining to usage of individual elements in the at least one data table.

Also provided, in accordance with another preferred embodiment of the present invention, is a data table management method for managing at least one data table, the method comprising recording information pertaining to usage of individual elements in the at least one data table; and evaluating the importance of data elements as a function of the information pertaining to usage thereof recorded by the data element usage monitor.

Also provided, in accordance with another preferred embodiment of the present invention, is a query-response retaining system, operative in conjunction with database apparatus comprising at least one data table storing a multiplicity of data elements and a query handler operative to receive queries pertaining to at least one of the multiplicity of data elements, the system comprising a query-response retainer operative to store each response to a query directed at the at least one data table, each in association with its respective query.

### BRIEF DESCRIPTION OF THE DRAWINGS

Preferred embodiments of the present invention are illustrated in the following drawings:

FIGS. 1A-49 include functional block diagrams of various components of a data table management system constructed and operative in accordance with an embodiment of the present invention, and flowcharts of various methods useful therewith. In particular, the methods shown in the flowcharts of FIGS. 2B, 3B, 4B, 5B, 6B, 8B, 9B, 10B, 11B, 13B, 15B, 20B, 21B, 22B, 23B-23C, 24B-24C, 25B, 26B, 27B and 28B may be useful in the operation of the system components illustrated in FIGS. 2A, 3A, 4A, 5A, 6A, 8A, 9A, 10A, 11A, 13A, 15A, 20A, 21A, 22A, 23A, 24A, 25A, 26A, 27A and 28A respectively.

FIG. 50 is a simplified functional block diagram of a data table management system constructed and operative in accordance with an embodiment of the present invention.

FIG. 51 is a simplified functional block diagram of data storage unit 5000 and data capture unit 5010 of FIG. 50, both constructed and operative in accordance with an embodiment of the present invention.

FIG. 52 is a simplified functional block diagram of classification server 5020 of FIG. 50, constructed and operative in accordance with an embodiment of the present invention.

FIG. 53 is a simplified functional block diagram of analysis unit 5330 of FIG. 52, constructed and operative in accordance with an embodiment of the present invention.

### DETAILED DESCRIPTION OF PREFERRED EMBODIMENTS

### Definitions

Target System—the enterprise system being sampled and analyzed
System of the invention—the capture and analysis system shown and described herein and variations thereof which might occur to the ordinarily skilled man of the art
Real-Time Capture—the sampling and storage of the stream of data packets of database requests and responses

Data growth is accelerating as companies capture more data about their customers, partners and products, due to the adoption of RFID, XML, and clickstream data collection. In addition, industry regulations such as Sarbanes-Oxley, SEC 17a and HIPAA are requiring companies to retain more and more data. As a result, IT departments are faced with terabyte and petabyte databases that are growing exponentially in costs and complexity. However, 80% or more of the data in these large databases is infrequently or never used. The result is that this 80% of inactive data is becoming a significant cost and performance burden to the 20% of data that is most valuable to the business.

Customers need a way to focus their applications, tools and resources on the most valuable data in a database. If they have a way to separate the approximately 20% actively used data from the 80% of inactively used data, then database users and administrators will be able to focus on the most critical business data, thereby reducing database management and storage costs, increasing database uptime and accelerating application performance.

Data Classification functionalities provided by certain embodiments of the present invention: Using intelligent data classification and partitioning as shown and described herein, customers will be able to do some or all of the following:
Reduce data mirroring costs: Data mirroring is all expensive task, consuming significant storage, bandwidth and management resources. Mirroring is performed in order to enable access to the data in case the primary system is not available. However, a significant portion of the costs is spent on mirroring data that is seldom or never used. IT departments need a way to reduce mirroring costs while ensuring 24/7 access to the data.
Reduce data cleansing costs: Data quality is a major IT priority, but data cleansing projects today are expensive, time-consuming and complex. Customers need a way to reduce cleansing cost by prioritizing efforts based on the value of the data. Then IT staff can typically clean important data first and get the important data cleansed within days or weeks, not months.
Improve information archiving: Information Lifecycle Management involves archiving data from a data warehouse or other databases, typically based on creation date or transaction date. The oldest data gets moved out even if it is still being accessed or has value to a user. Customers need a system that enables theme to use their existing information archiving tools to move out data based only when it no longer has business value (i.e. no one uses it anymore), and not simply because it has reached a certain age.
Reduce database downtime: During system backups, upgrades and other maintenance tasks, the source database may not be available for a period of time. IT departments may be able to reduce system downtime by performing appropriate maintenance tasks only on the actively used portion of the database. For instance, in the event that a database restore is required, customers need a way to enable fast restoration of the important data first. They also need a way to reduce database replication time by enabling replication of only actively used data.
Reduce storage costs: Although storage prices are falling by approximately 30% per annum, the amount of data is increasing at a faster rate. This means that overall storage costs continue to increase. Once inactive data can be identified, it can be transferred to lower-cost real-time storage such as SATA RAID disk while keeping the active data on higher-performance Fibre Channel storage. Today, the data classification process (i.e. determination of which data goes where) is manual, expensive and inexact, typically requiring a 2-3 month process by a team of data consultants. Customers need a way to automate and optimize data classification for storage tiering by identifying the most actively used data.
Optimize queries: Typically, when an application executes a query, it may be required to perform a full table scan, through massive amounts of inactively used data, in order to locate the relatively small number of desired records. Customers need fast, direct access to the most actively used data. Otherwise, IT departments incur expenses to speed up access—by expending DBA time to pre-fetch data or to create summary tables, and/or by throwing additional computing resources at the problem.
Accelerate enterprise applications: The performance of applications, such as ERP, CRM (Customer Relationship Management) and SCM (Supply Chain Management), can deteriorate as the amount of data in these systems grows. Customers need a way to maintain system performance, even as the amount of data increases.
Improve data warehouse ETL: ETL (Extraction, Transformation, Load) is the process of reformatting and moving data into the data warehouse from multiple operational systems, usually performed nightly so that the data is up-to-date and ready the next morning. As the size of data warehouses increase, it becomes difficult to perform all of the ETL tasks on the data within its allocated window of time. Since a significant portion of this data is not ever used, customers need a way to perform ETL on the data that is actually used.
Enhance business intelligence: Customers need a way to identify which data is actually being used by users and which data is not. This information can be used by marketing to discover that it is overlooking data that could be valuable for analysis purposes. The information can also help IT staff see that there is a lot of data being maintained in the database that the users do not really need.

A method for usage-based data qualification provided in accordance with an embodiment of the present invention preferably comprises the following steps:

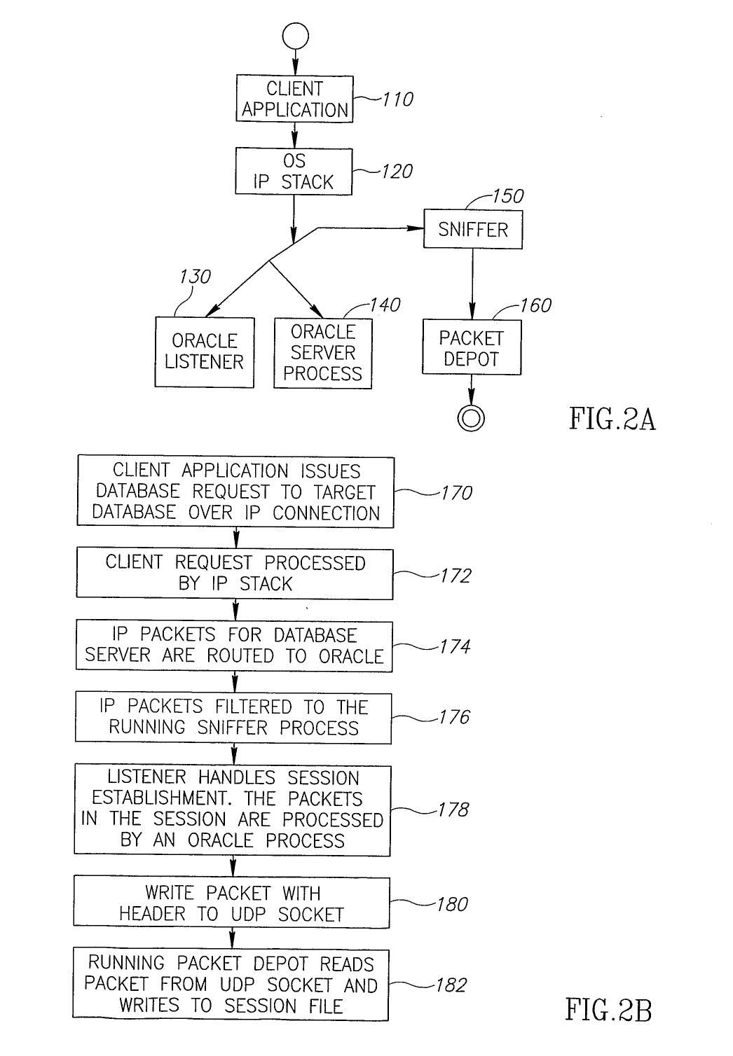

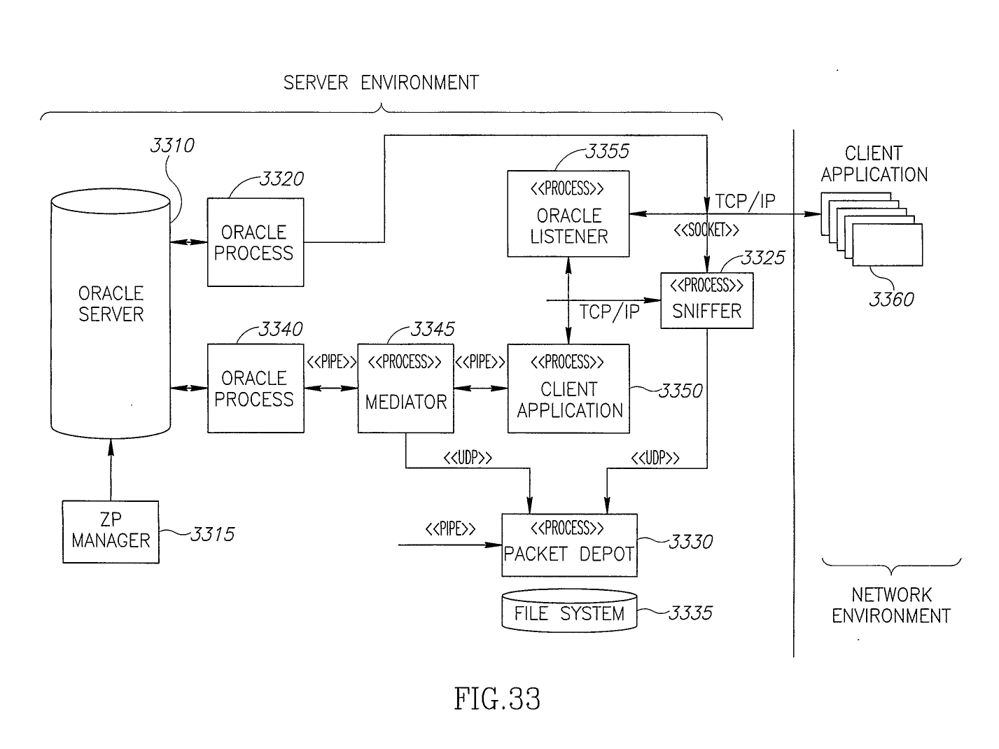

1. Gather the database-client communication data.
Oracle can communicate with local client and with remote clients.
Each (local and remote) uses a different method to communicate with Oracle.
To analyze the real usage of data we first have to gather all of the communication between Oracle and its clients. Preferably the gathered communication data comprises a multiplicity of client-Oracle dialogue protocols, each dialogue protocol comprising a sequence of dialogue protocol portions including client-to-Oracle dialogue protocol portions and Oracle-to-client dialogue protocol portions.
   a. Gather all communication data which has arrived via the network from remote clients using a sniffer constructed and operative in accordance with a preferred embodiment of the present invention e.g. as described herein and with reference to FIG. 2A (especially at 150), FIG. 2B, and “Real time components”, “Components” and “Sniffer”, inter alia.
   b. Gather all communication data initiated by local clients using a Mediator constructed and operative in accordance with a preferred embodiment of the present invention e.g. as described herein and with reference to FIG. 33 and “Real time components”, “Components” and “Mediator Process”, inter alia. The Mediator is typically able to represent itself to the Oracle database as an Oracle's client while representing itself to the Oracle's client as Oracle database thereby allowing the mediator to “see” all data communication between Oracle and the client.
   c. Get all gathered data to one focal point for storage; this storage location is termed herein the Packet Depot, in which all packets that belong to the same session are typically stored in a flat file. The Packet Depot communicates with all data agents (e.g. Sniffers and Mediator), gets communication data from them, organizes it and prepares it to the next phase.

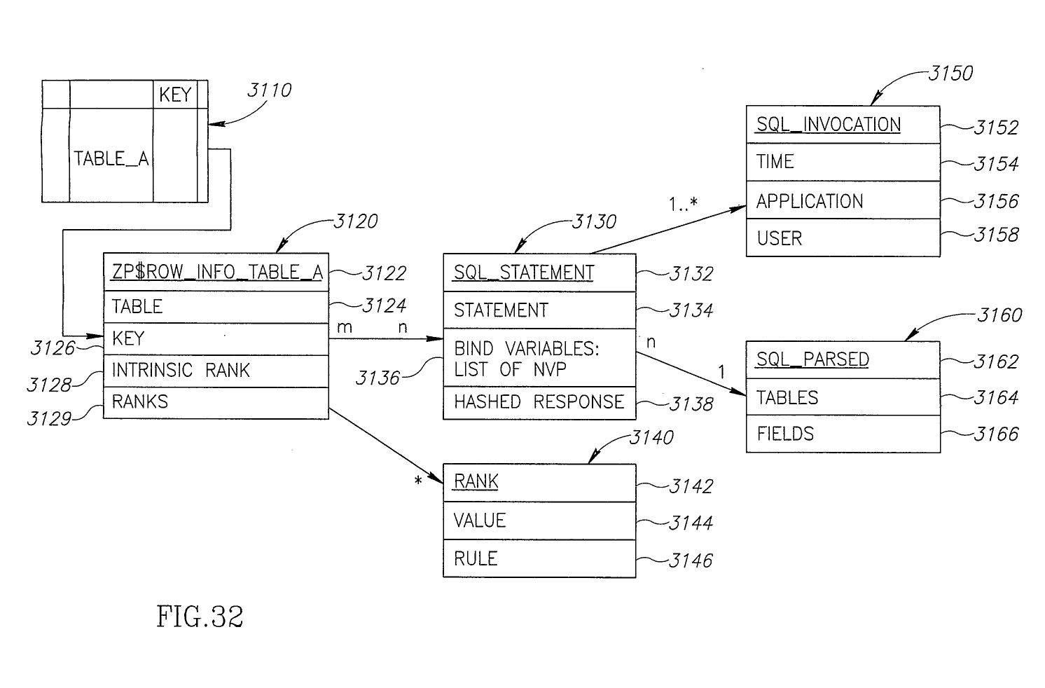

2. Understand the communication data including deriving query-response pairs therefrom.
a. The information which is derived in the course of the understanding process typically comprises the following:
   i. Connection information (Oracle user name, OS user name, client's computer name, client's program name
   ii. SQL Statements.
      This is the query or real data requested by the user.
   iii. Bind Variables.
      Oracle supports sending SQL statement with some missing information, and sending this missing information as Bind Variables later on.
   iv. Result sets, comprising the query response, or REAL data that the Oracle's client is getting out of Oracle, including Usage, as described herein.
   v. Optionally, additional information regarding communication flow and errors.
b. The needed information is stored in the packets that the sniffer/mediator catches, as described herein, inter alia with reference to Table 5. After extracting this information, parse and understand what exact database resources (rows, columns, etc.) the SQL statement accessed. Typically, for each resource (row, column, record, field), a counter is incremented for each access thereto i.e. usage thereof.
c. Optionally, as described herein e.g. in Method C, step 7, more data regarding keys, to identify records, is provided by building and running SQL statements (re-execution) to retrieve this data which is then stored in the repository described herein.
d. Record real usage (incrementing for each relevant usage) and rank data elements based on recorded real usage
e. After having and understanding all data, it is possible to filter data to determined relative usage based on criteria like time slices, user name, program name and others. For example, it may be desired to focus exclusively on usage of the database between 8 AM and 12 noon.
f. Each data element that has been used will get a score and may, typically subsequently, also get a rank, based on how much it has been used.
g. There is the ability to set more than one rank to each data element based on different filters/weights
The above process is preferably operative in conjunction with a repository, e.g. as described in FIG. 32, which typically includes at least the following tables or other data representations:
(i) a dialogue table including, for each of the multiplicity of dialogues taking place between the Oracle or other database and its clients, query contents, response contents, and other dialogue characteristics such as the time at which the dialogue took place and the identity of the client.
(ii) A usage table including, for each row and/or column and/or record and/or field and/or other portion of the database: an ID of the row, column or record (e.g. if the record represents an order, the serial number of the order), and at least one score representing amount of usage of the individual row, column, record or field. This score is typically incremented each time the row, column, record or field is used.

It is appreciated that the methods and apparatus shown and described herein are applicable to any type of data base and data table, applicability not being limited to data warehouses specifically nor to Oracle technology specifically which are mentioned herein merely as one possible implementation and by way of example.

The system of the present invention typically comprises some or all of the following elements:
1. Real time capture of query and response—The system captures query request and response data from actual usage of a data base, with minimal footprint and impact on the running production system.
2. Configurable Analysis of database usage—The system analyzes the captured data, identifies the unique rows in the response records and tracks the row usage, storing the session contest information such as user, invoked SQL query text, application and time.
3. Ranking—The system calculates a rank for each accessed row, column, table and cell. The rank expresses the degree of usage of the row, column, table and cell as expressed in the captured data.
4. Reporting—The system generates reports showing the database usage through the rank. The reports show usage and several levels, including at the level of the row, column, table and cell, and the invoking SQL query.
5. Generation of scripts—The system generates SQL for usage-based management of the production database warehouse tables. The SQL is configured for the type of production data warehouse database.
6. Applications—The system supports the following applications though usage-based management of the data base:
   a. Usage based intelligent partitioning—support and script generation for table partitioning based on usage ranking. For example, the tables would be partitioned by an additional column for the usage ranking. This would enable the heavily used rows to be partitioned on higher performance storage.
   b. Dynamic and in-place partitioning—real-time query rewriting and routing to rewritten tables that are redefined to optimize usage. For example, a table would be redefined into a set of tables based on the data usage. A table EMP would be redefined as EMP_hot, EMP_cold and EMP_frozen. Queries for the EMP table would be identified and rerouted to the appropriate table based on the identification of the query and its response.
   c. Optimization of table storage among different storage classes/types based on optimization criteria—for example, given different storage classes [in performance and cost], the allocation of tables to storage can be optimized based on desired criteria.
   d. Data Warehouse ETL (extract, transform and load) intelligent loading based on usage—this allows for selection of the subset of data that is most likely to be used, and the selection of the most appropriate storage for the loaded data.
   e. Prioritized restore of backed up data—prioritized data restore based on the data usage patterns.
   f. Data mirroring based on the data usage—optimization of the mirroring infrastructure [hardware, systems, network bandwidth] by mirroring based on usage.
   g. Archiving based on least usage—data that is not in use can be selectively archived
   h. Usage prioritization of data cleansing—data cleansing can be made more cost effective by prioritizing the cleansing process by data usage.

The high-level structure of the system shown and described herein may be partitioned into three tiers:

Real-Time Data Capture Tier: The real time tier contains system components that are involved in the capture of the flow of database messages. These components require access to the database message flow and intercept these messages for analysis. This tier is hosted on the target database platform.

Analysis Back End Tier: The analysis tier contains the system's data usage analysis components. These components include:
Captured data analysis—components which construct the logical session information from the raw database messages.
Usage analysis—components that use the logical session information to construct the row ranking.
   The analysis tier can be hosted on any platform that has access to the captured data and to the database.

Front End User Tier: The front end tier contains the system components that interact with the end user. This includes the reporting components, the management interface components and the presentation pages and logic.

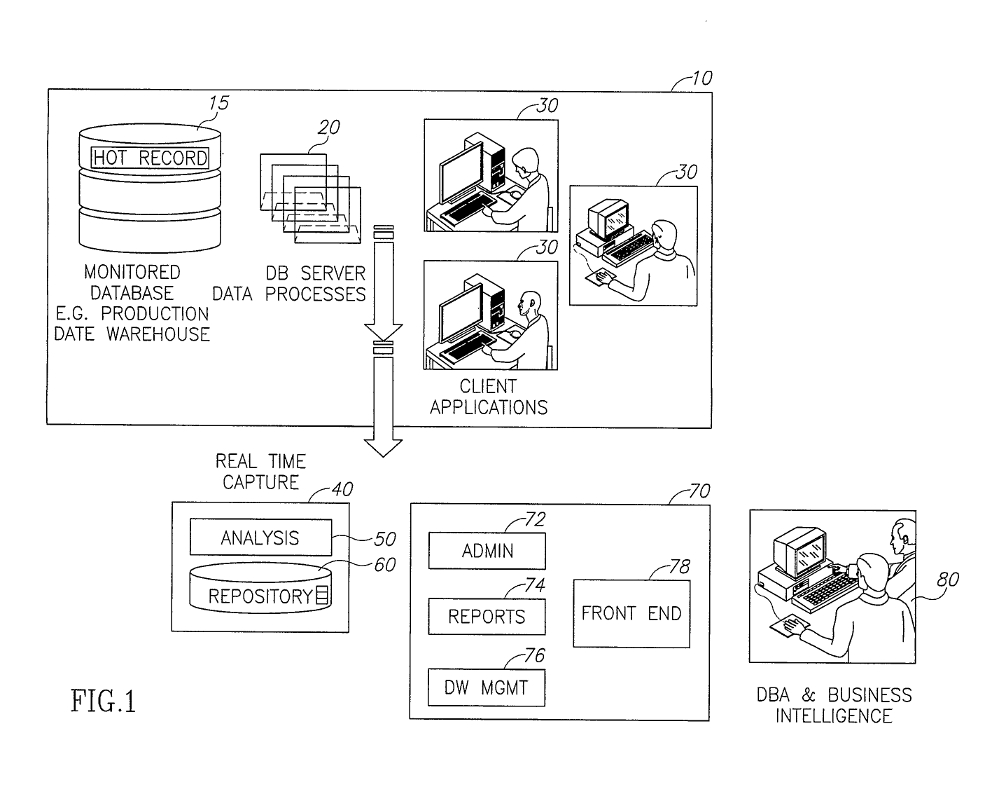

A high-level architecture of a data table management system constructed and operative in accordance with a preferred embodiment of the present invention is illustrated in FIG. 1. System Operation according to an embodiment of the present invention is now described.

Real Time Capture: The real time capture subsystem captures the flow of database requests and responses at the level of database communications packets. The sub system supports several configurations and protocols for a distributed database. In the case of the Oracle Network Model, the subsystem supports capture through TCP packet capture as well as capture through pipe interception of the Oracle server processes.

Real Time Capture of the Database request by TCP, according to an embodiment of the invention, is illustrated in FIG. 2.

The operation of request capture using TCP based packet capture is described in FIG. 2. The system's Sniffer process intercepts the TCP packets that are designated for the Database processes. These packets are with written to the Packet Depot along with the session context information.

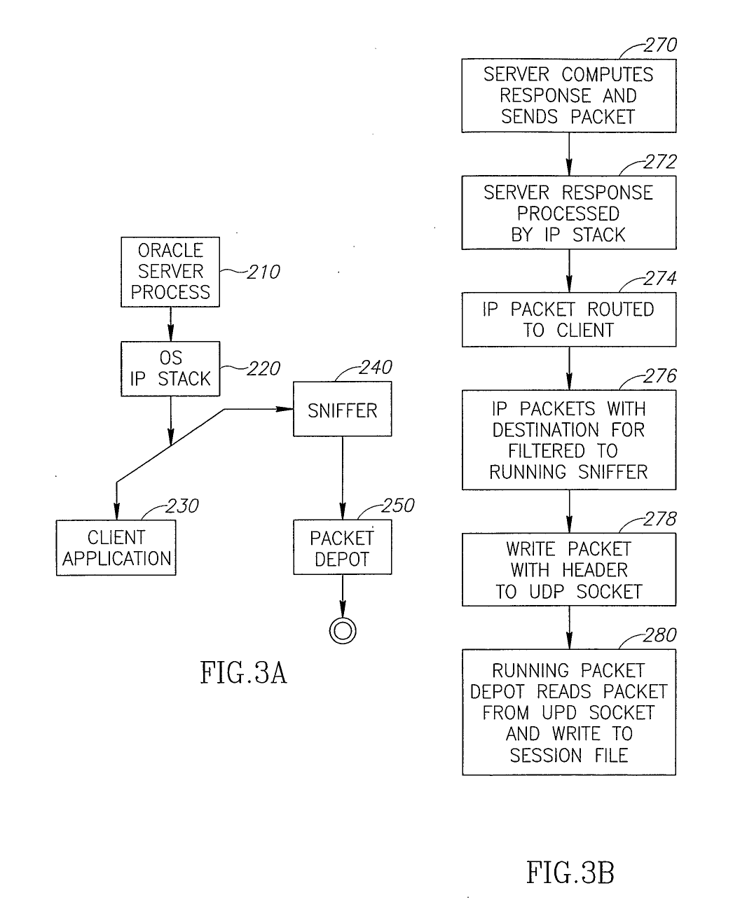

Real Time Capture of the Database response by TCP, according to an embodiment of the invention, is illustrated in FIG. 3. The operation of capture of the database response using TCP based packet capture is described in FIG. 3. The system's Sniffer process intercepts the TCP packets that are designated for the Database clients. These packets are with written to the Packet Depot along with the session context information.

Analysis: The analysis process is designed to be a pipeline, processing the captured packets in stages from the raw data through resolved detailed data structures. The design of the pipeline and the data structures are described in the system design section of this document.

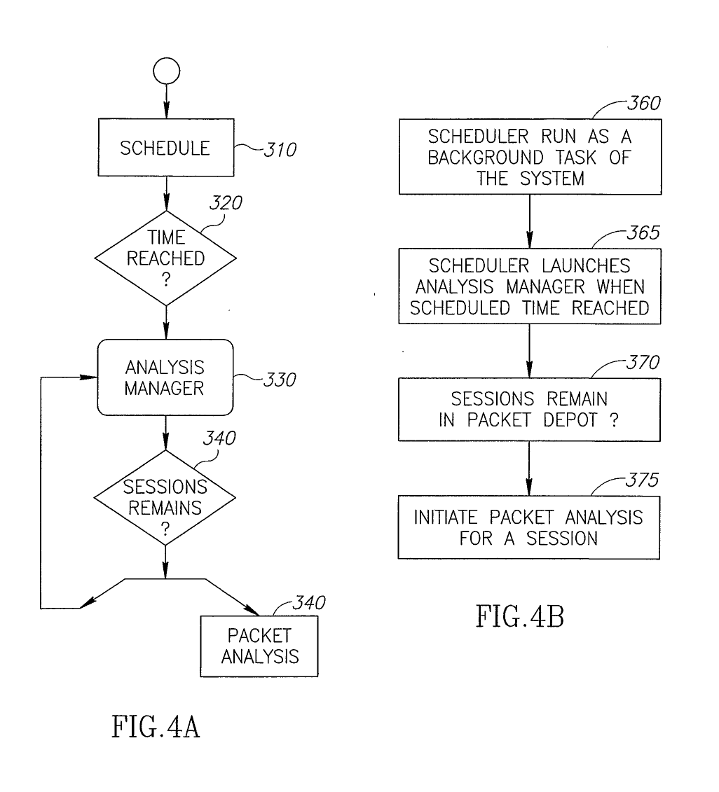

Scheduling of Analysis and launch of packet analysis according to an embodiment of the invention, is illustrated in FIG. 4. The operation of capture of the Analysis subsystem is described herein with reference to FIG. 4. The Analysis is run on a configurable schedule. The Analysis manager launches the packet analysis component to process the captured packets.

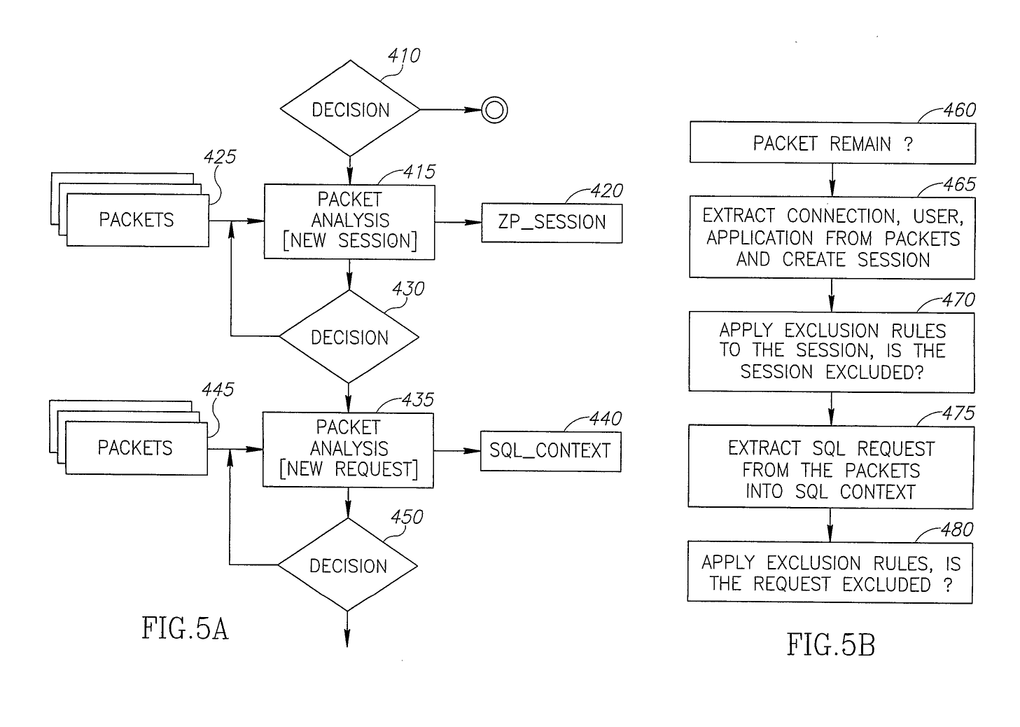

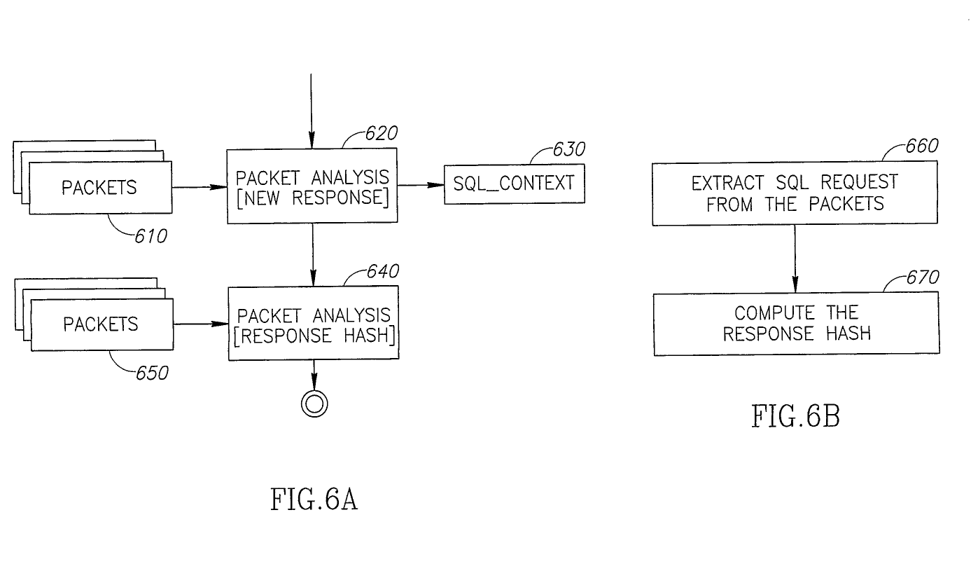

Packet Analysis, according to an embodiment of the invention, is illustrated in FIGS. 5 and 6. The processing of the raw captured data packets by the packet analysis is described with reference to FIGS. 5 and 6. The packet analysis component processes the raw packets, extracts the session context information and then extracts the sql requests and the associated responses.

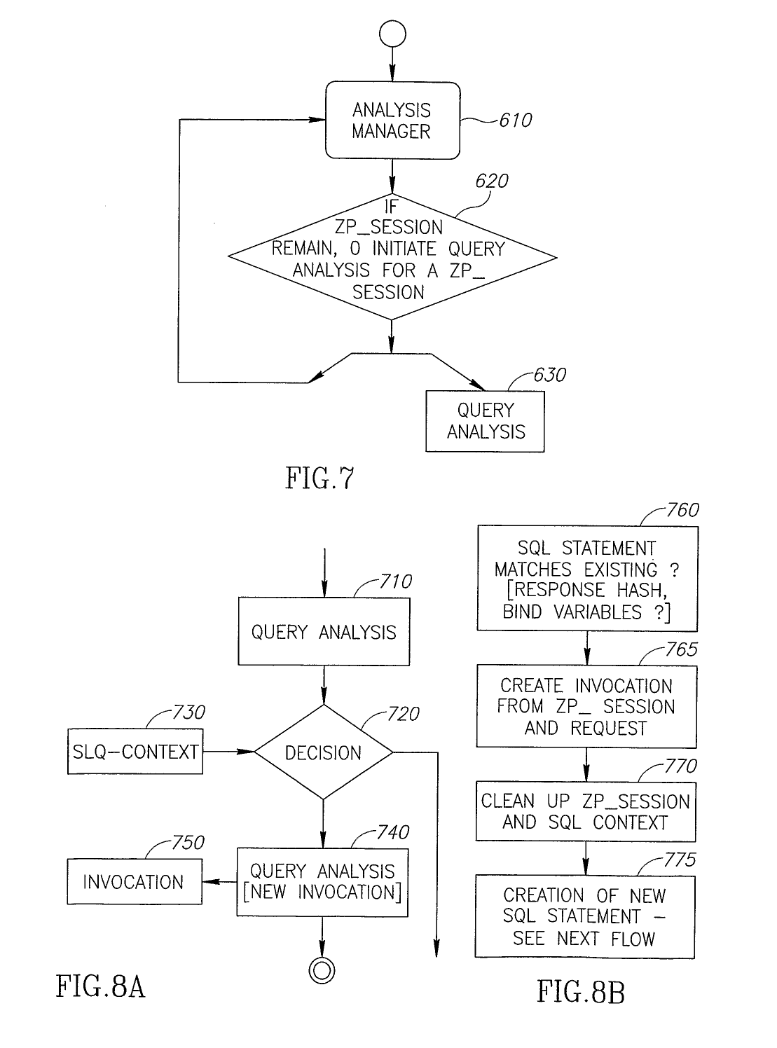

Launch of Query Analysis, according to an embodiment of the invention, is illustrated in FIG. 7. The data structures generated by the packet analysis are processed by the query analysis. FIG. 7 describes the launch of query analysis by the analysis manager.

Query Analysis, in the case of an existing SQL statement, according to an embodiment of the invention, is illustrated in FIG. 8. The query analysis identifies the unique rows retrieved by the query. FIG. 8 describes the analysis of query data for queries that have been previously identified.

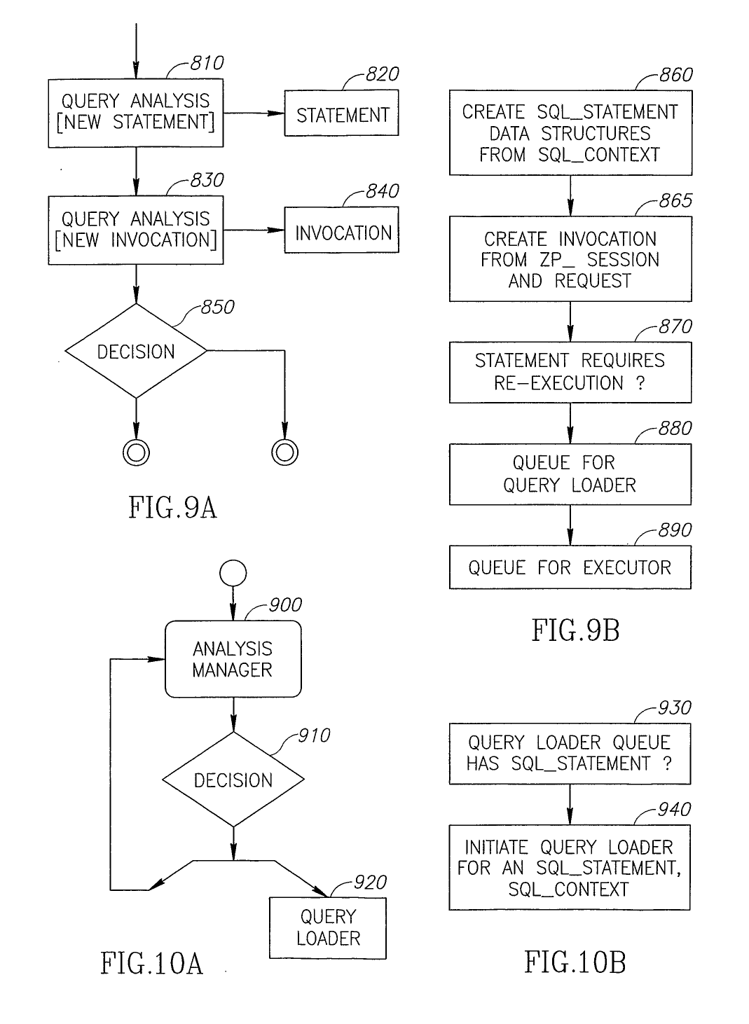

Query Analysis, in the case of a new SQL statement, according to an embodiment of the invention, is illustrated in FIG. 9. FIG. 9 describes the analysis of new queries. The query analysis creates new data structures for the SQL request, and then either submits the response to the query loader for analysis, or to the executor for re-execution.

The query loader is responsible for extraction of the unique row information from the query response. The query loader may be used to analyze the data of the original response, if it contains unique keys, as well as in the analysis of re-execution results. FIG. 10 illustrates the launch of the query loader by the analysis manager.

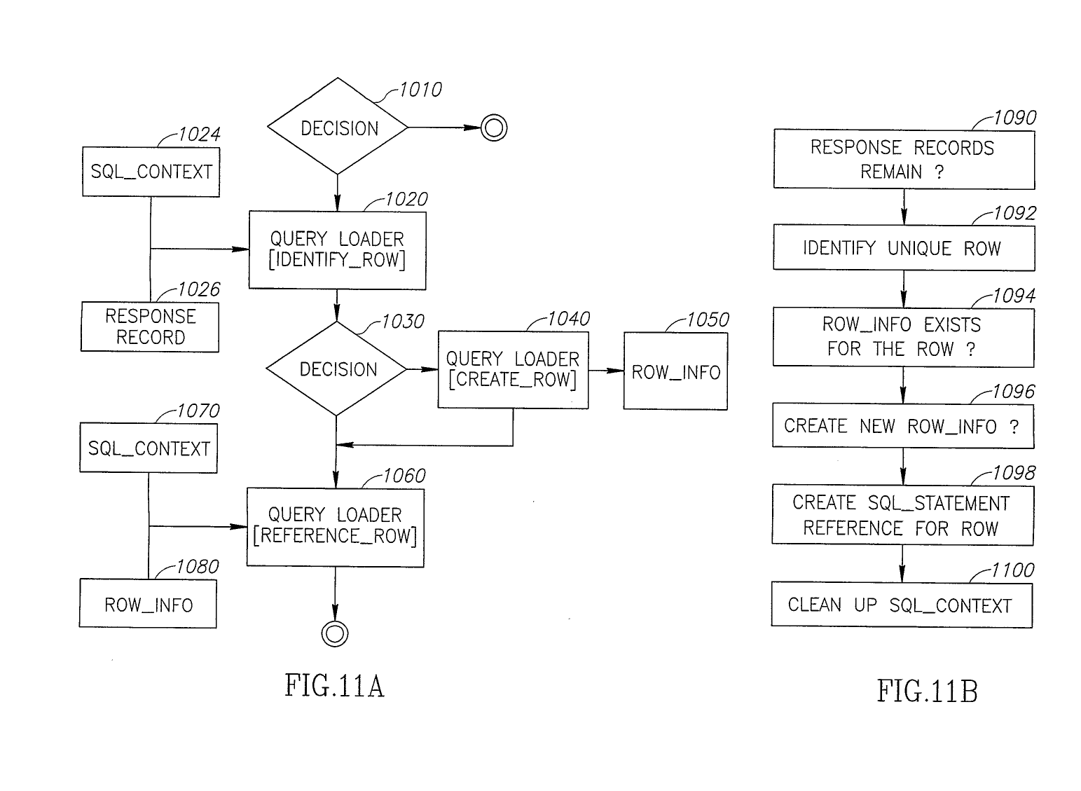

FIG. 11 illustrates the query loader and the extraction of row information from the query response.

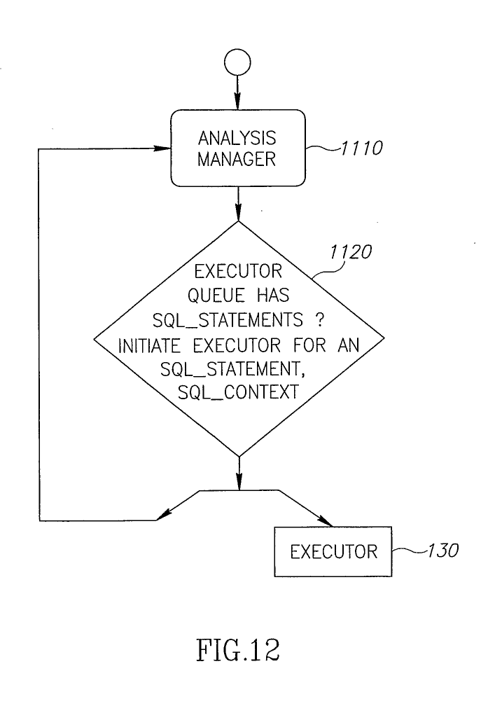

The executor is responsible for re-writing queries that do not contain a unique key in the response records or that meet other re-execution criteria outlined later in this document. FIG. 12 illustrates the launch of the executor by the analysis manager.

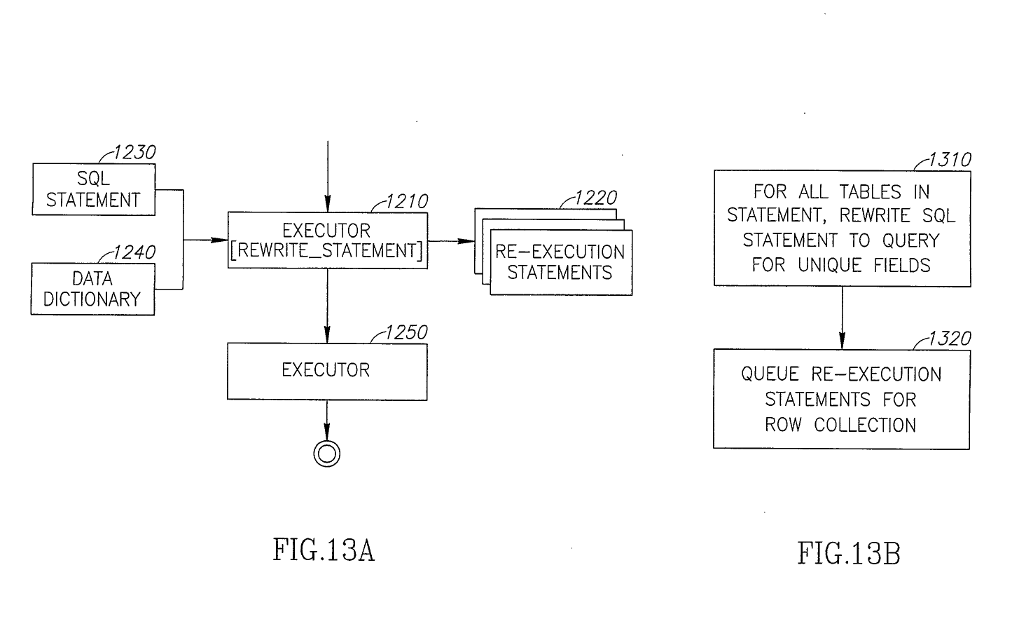

FIG. 13 illustrates the executor and the query re-writing to retrieve unique keys on re-execution of the query.

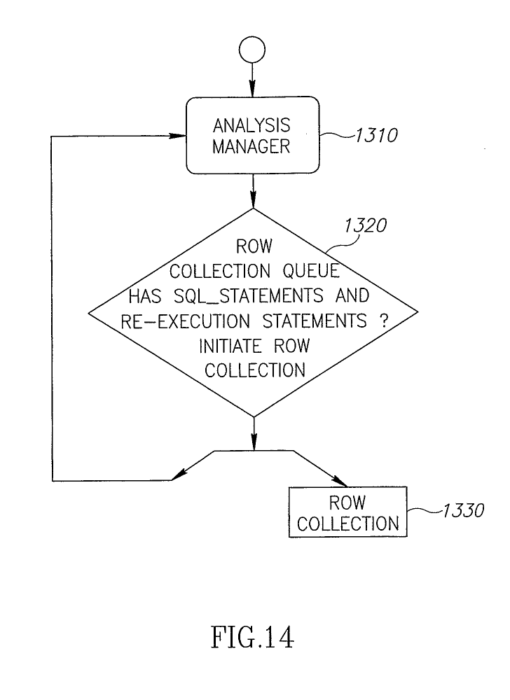

The row collector is responsible for performing re-execution of queries with the target database, and collecting the results. FIG. 14 illustrates the launch of the row collector by the analysis manager.

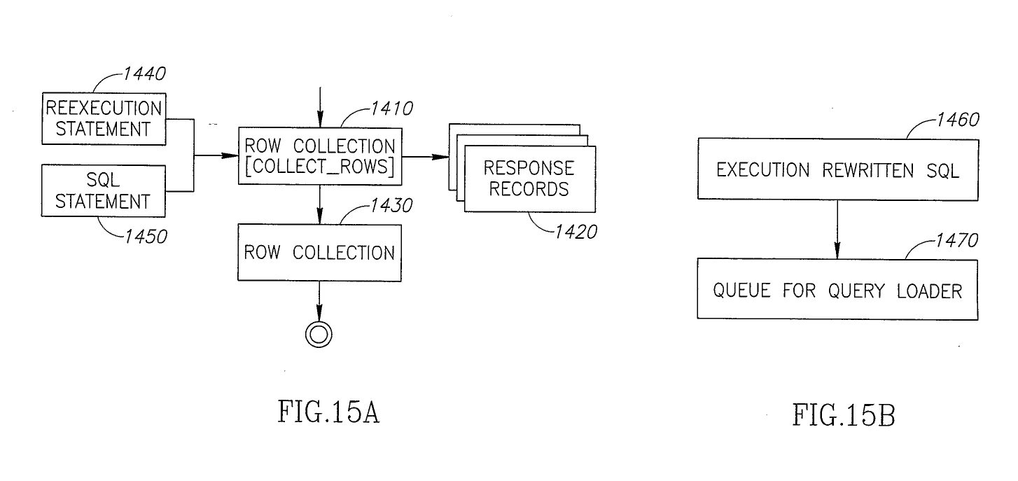

FIG. 15 illustrates the row collector and the re-execution of the queries.

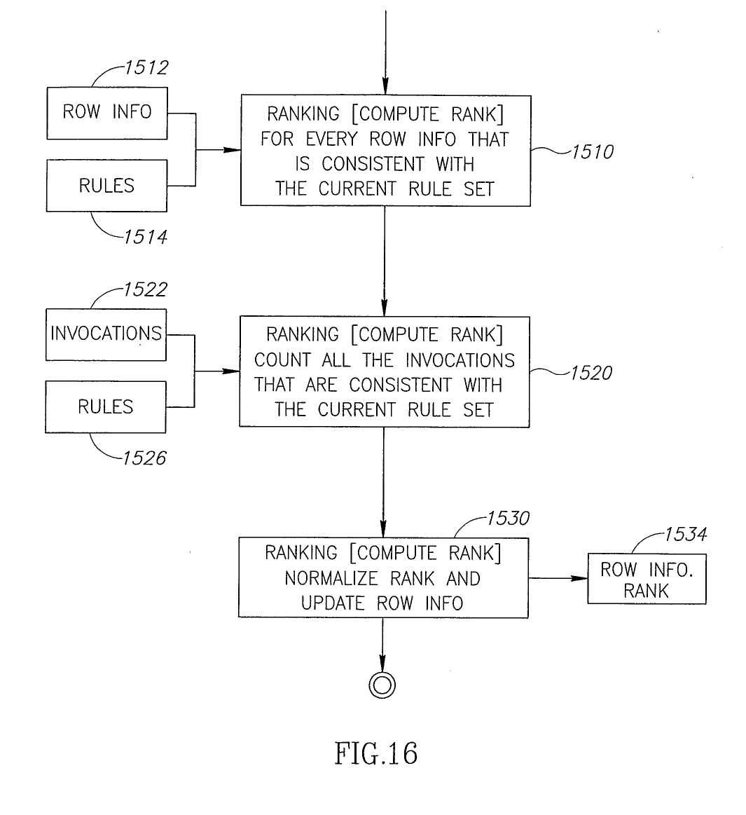

FIG. 16 illustrates the computation of the row, column, table and cell ranking. The ranking is an indicator of the relative usage of the row, column, table and cell, as a function of the overall database retrievals. Additional ranking computations can typically be applied, using user-defined selection rules. For example, the analyst may choose to exclude the impact of usage by DBA application on the ranking.

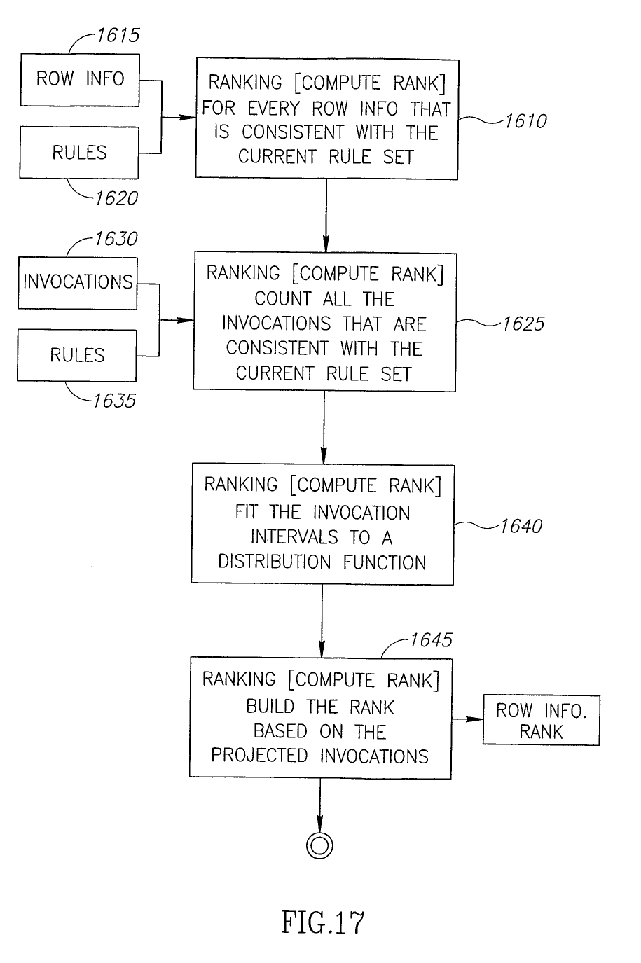

Ranking based on usage distribution curve-fitting, according to an embodiment of the invention, is illustrated in FIG. 17. Additional ranking functions can typically be applied. A suggested ranking function shown in FIG. 17 uses curve fitting techniques to fit the row usage count to a distribution function, and then to rank based on the prediction of future usage. This type of ranking function is effective in predicting the future usage of the rows, which is critical for applications such as intelligent partitioning described in this document. This model also ages the older usage information, and emphasizes the trends of increasing usage.

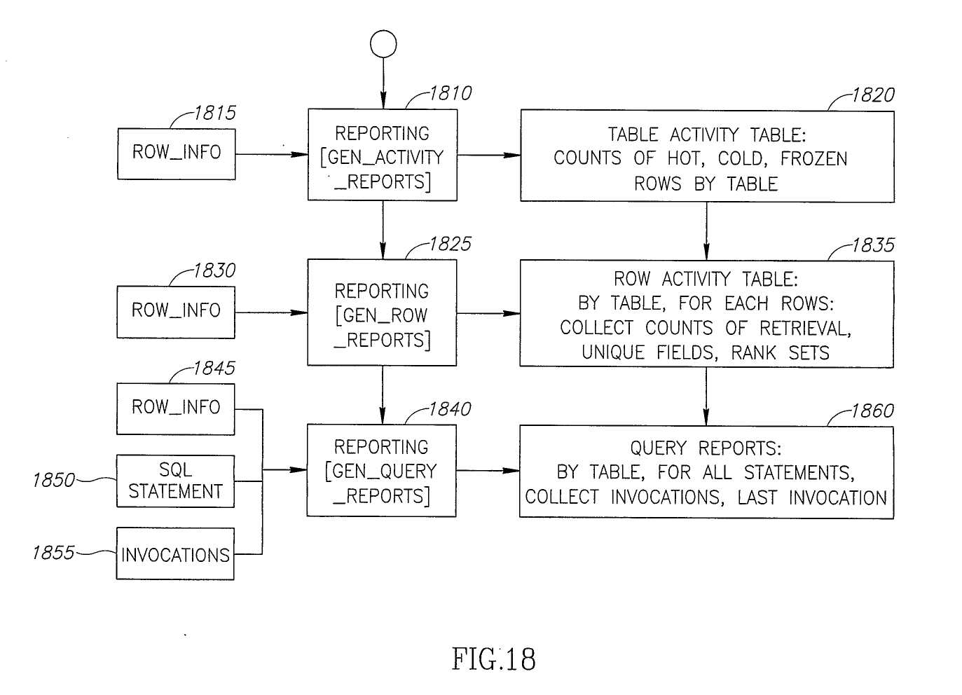

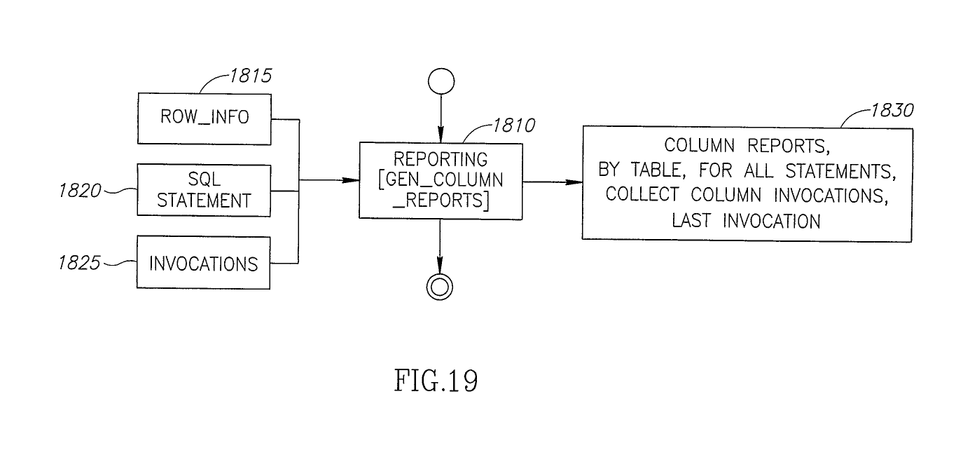

FIGS. 18 and 19 illustrate report generation based on the analysis results.

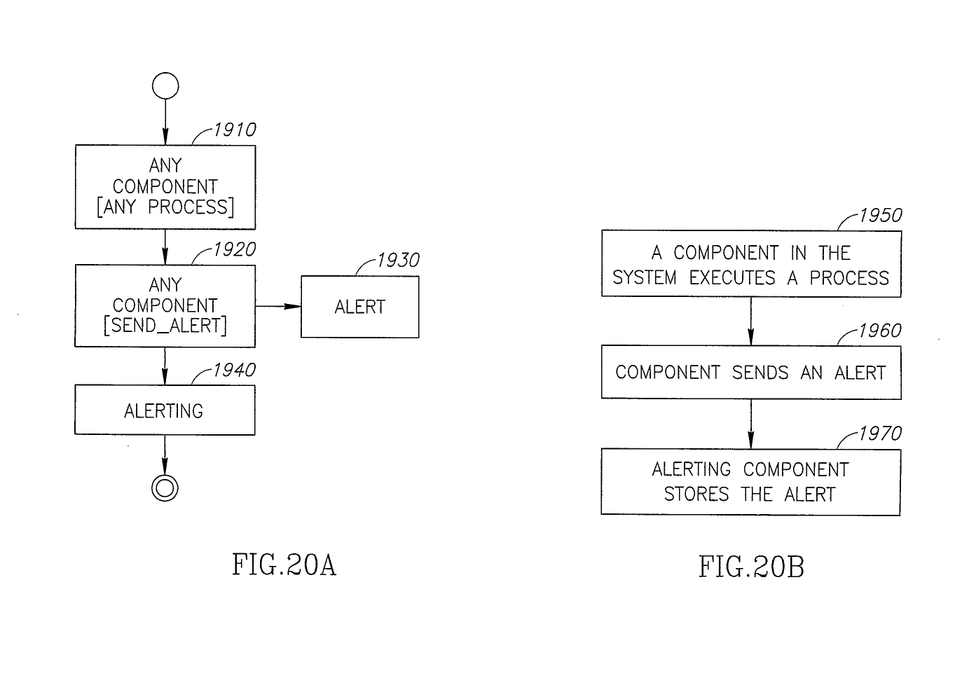

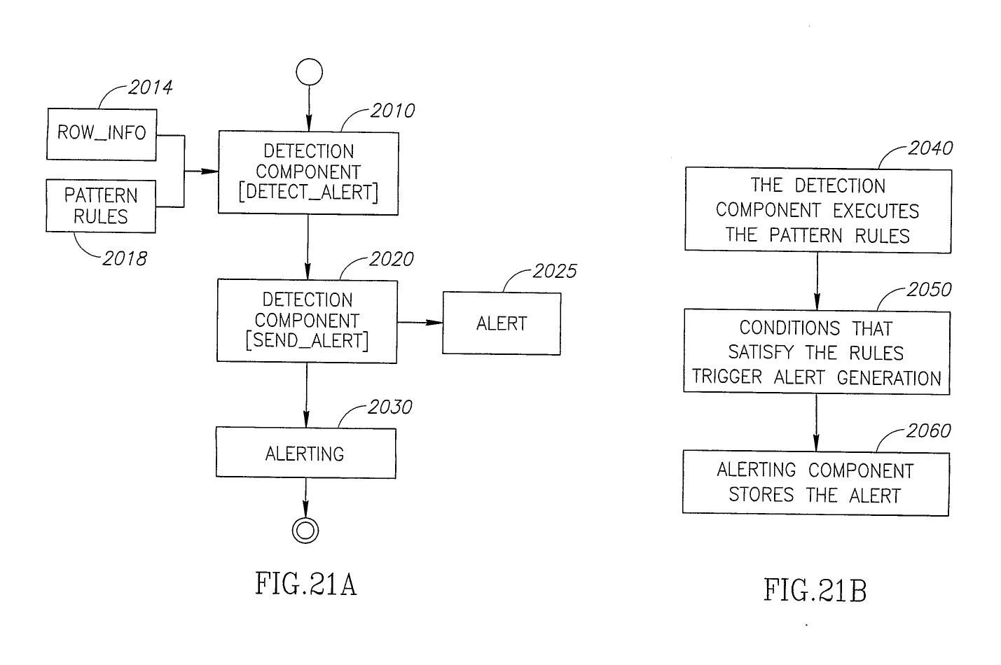

System Alert generation, according to an embodiment of the invention, is illustrated in FIGS. 20 and 21. The system notifies the user of operational issues, errors and faults through a system of alerts as described in FIG. 20. The system notifies the user of data condition and critical data issues in the target database through a configurable system of data alerts as described in FIG. 21.

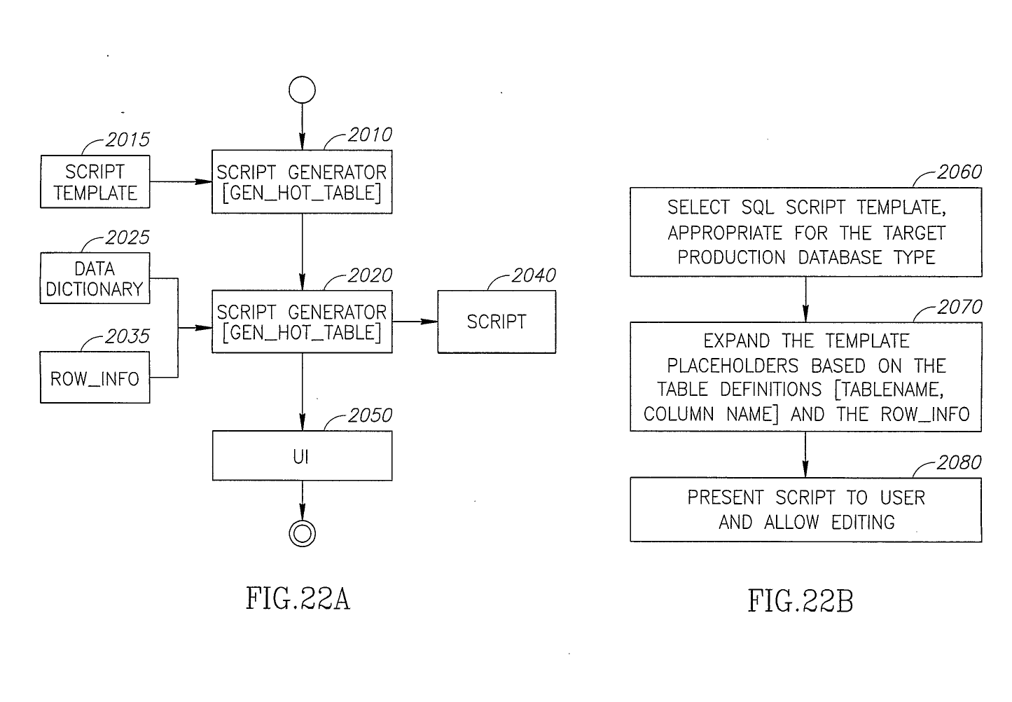

The system can typically generate SQL scripts at the user's request for usage based management of the target database. A process of script generation is described in FIG. 22.

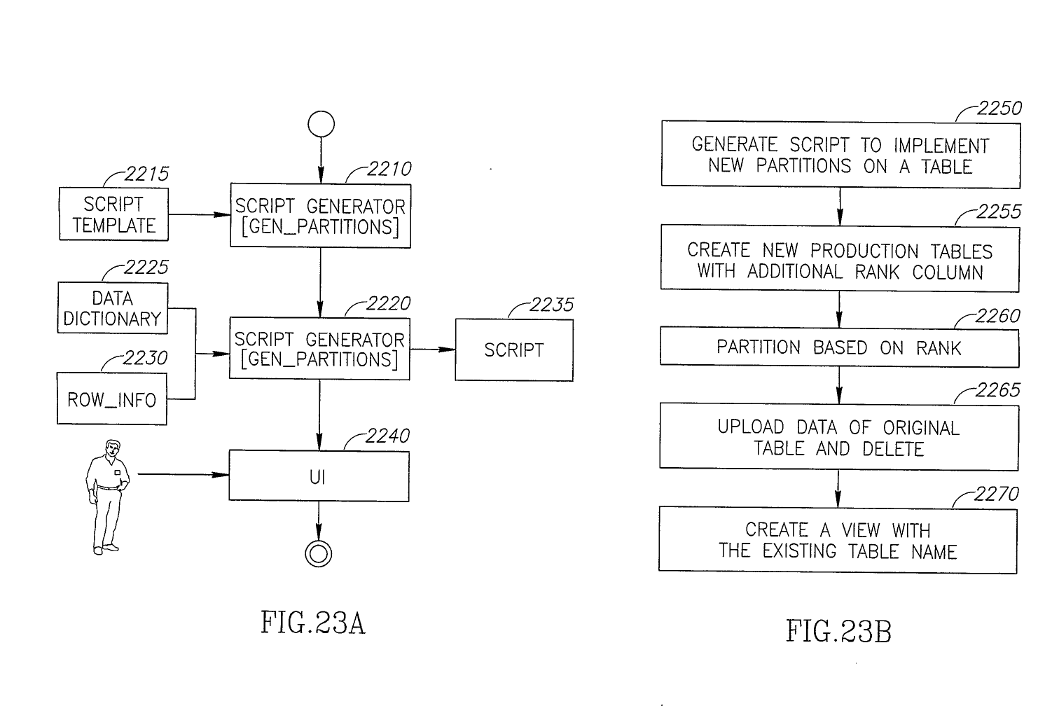

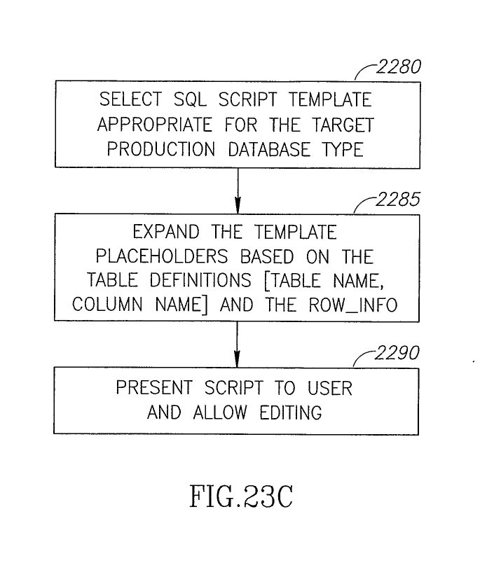

The system can typically be used for intelligent usage based partitioning, as shown in FIG. 23. In this application, scripts are generated for partitioning tables based on the row ranking of the table rows.

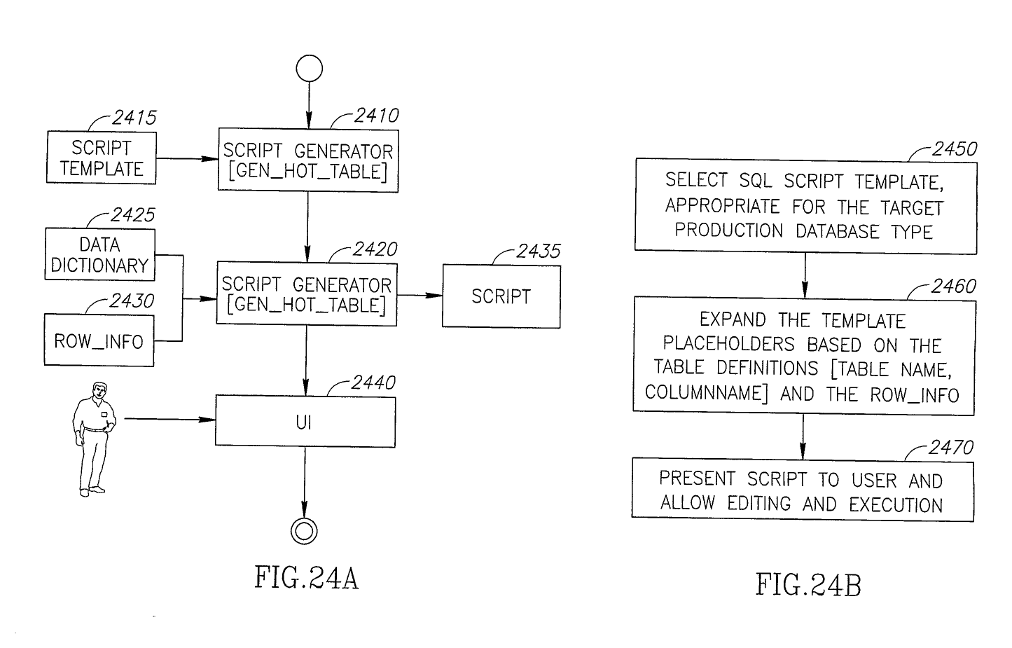

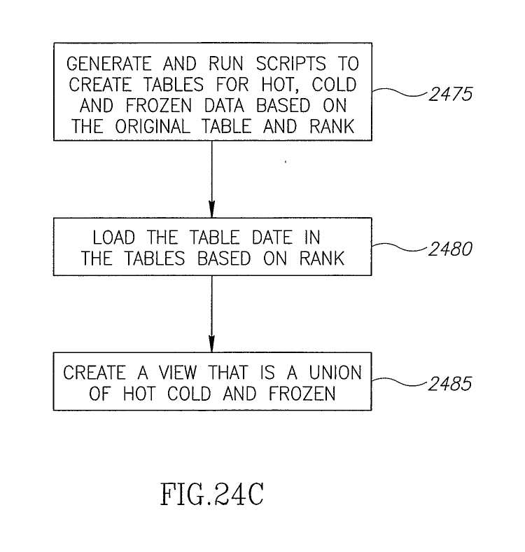

Script generation for in-place dynamic re-routing, according to an embodiment of the invention, is illustrated in FIG. 24. The system can typically re-route queries to a series of tables which distribute the original table data based on the row ranking. In this application, the user would use the system's script generation to generate a script for distributing the original table across tables for the hot, cold and frozen data used for intelligent usage based partitioning, as shown in FIG. 24.

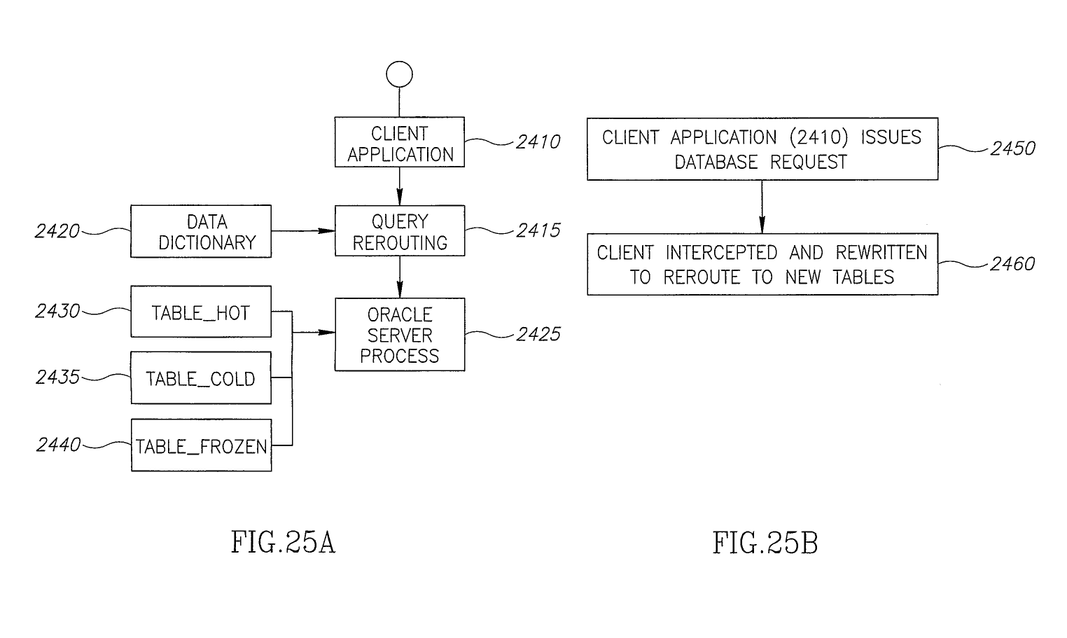

Real-time query re-routing, according to an embodiment of the invention, is illustrated in FIG. 25. As shown, the system then intercepts each query for the table, analyzes the sql and rewrites the query to route the query to the designated table.

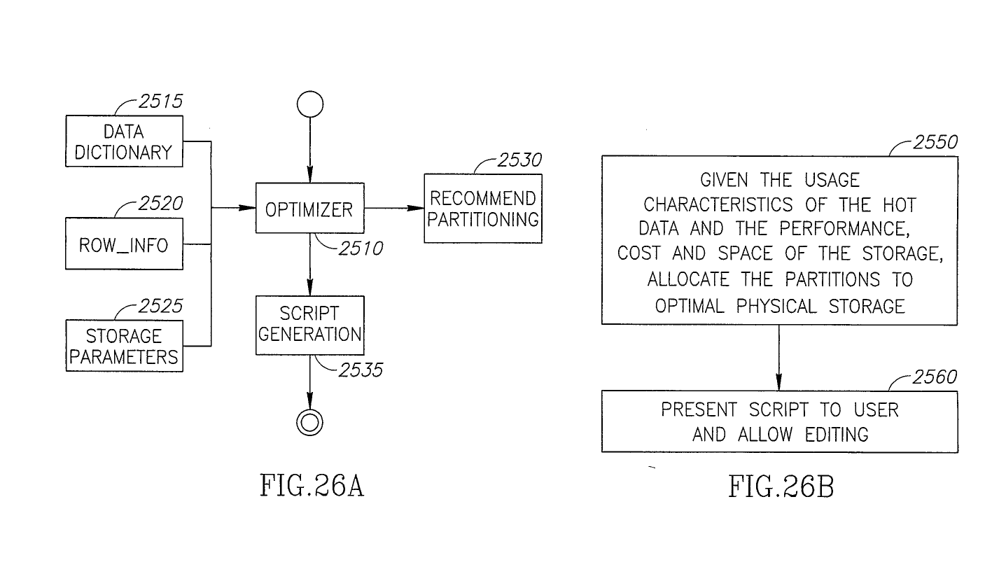

Storage-optimized usage based partitioning, according to an embodiment of the invention, is illustrated in FIG. 26. The system can typically recommend and generate scripts for partitioning and/or distribution of data to tables that optimize the use of different classes of storage, as shown in FIG. 26.

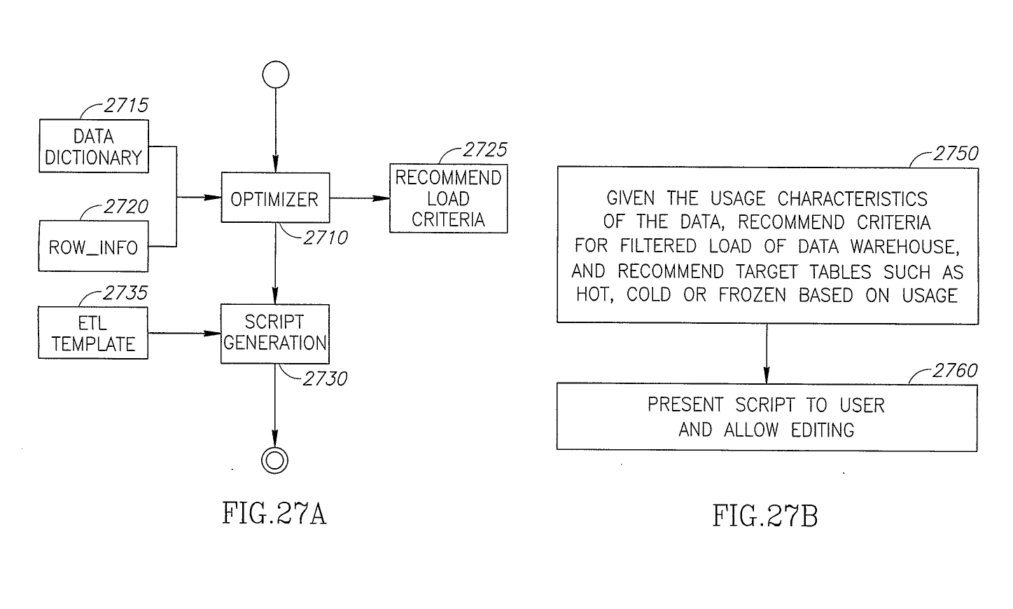

ETL based on usage analysis, according to an embodiment of the invention, is illustrated in FIG. 27. The system can typically recommend and generate scripts for filtered loading of data warehouse ETL, and recommend which tables to use as the target of the load operation base on usage as shown in FIG. 27.

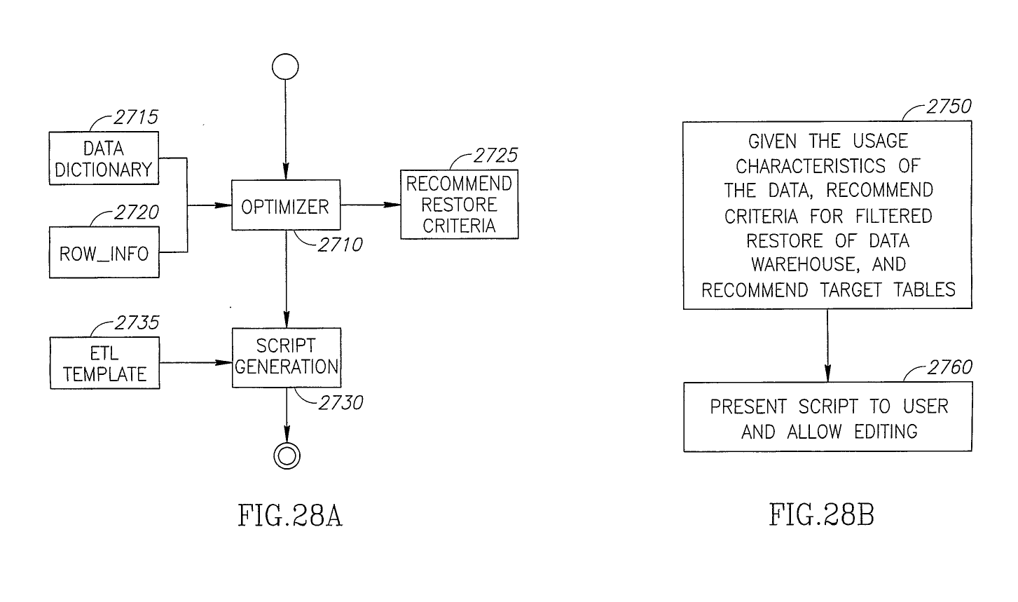

Data restoration based on usage analysis, according to an embodiment of the invention, is illustrated in FIG. 28. The system can typically recommend and generate scripts for filtered restore of data warehouse backups, and recommend which tables to use as the target of the load operation base on usage as shown in FIG. 28.

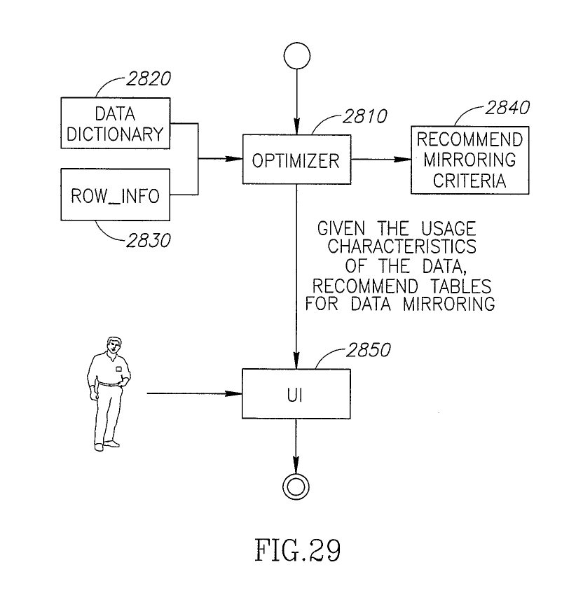

Data mirroring based on usage analysis, according to an embodiment of the invention, is illustrated in FIG. 29. The system can typically recommend criteria for which tables to use for cost effective data mirroring, as shown in FIG. 29.

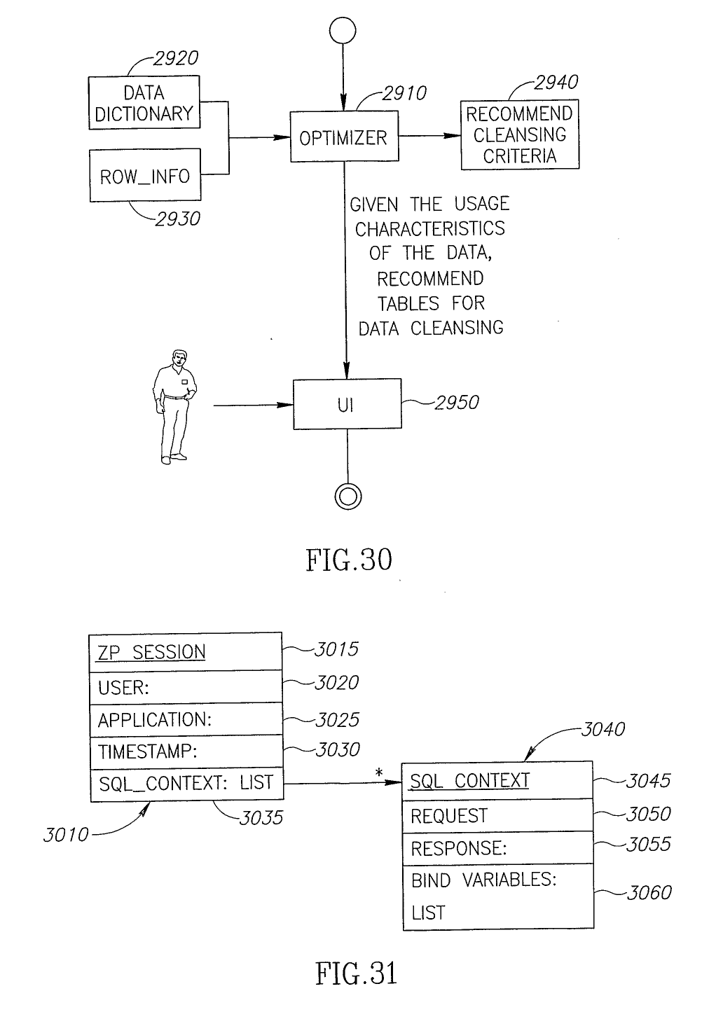

Data cleansing based on usage analysis, according to an embodiment of the invention, is illustrated in FIG. 29. The system can typically recommend criteria for which tables to use for cost effective data cleansing, as shown in FIG. 30.

The component design and key data structures used in an embodiment of the system are shown and described herein.

### Real Time Data Structures

Raw_Data_Packets: The raw_data_packets structure describes the captured data that has been stored by the system's real-time capture process. The raw_data_Packet structure typically comprises two elements:
Header—the descriptive information on the message context [user, time, application, message length]
Message—the message as captured. In the case of Database, this message is in BEQ format
Header: A header constructed and operative in accordance with an embodiment of the invention comprises an outer header and an inner protocol specific header.

TABLE 1
Outer header

| | | |
|---|---|---|
| Packet total length | Long | |
| Packet type | Long | Identifies the type of protocol of |
| | | payload and the sniffing |
| | | technology - for example Net8 |
| | | version from a tcp packet sniffer |
| | | vs. oci pipe sniffer - also session |
| | | info is different |
| Type Specific Header | Variable | |
| Message | Variable | |

### Inner Header—Protocol Specific

The Inner Header depends is specific for the source protocol of the capture—which could be TCP in the case of sniffing of the TCP stack, or Pipe—in the case of capture through a spawned process.

TABLE 2
TCP Capture Packet:

| | | |
|---|---|---|
| TCP Source | IP Address | |
| TCP Destination | IP Address | |
| TCP Port | Integer | |
| Time stamp | | If it is a real time packet, vs. something |
| | | like select v$ for historical info with |
| | | no time stamp [can be empty] |

It is noted that the TCP sniffer cannot determine the process id or application name.

This information is added later in the analysis by the packet analyzer.

TABLE 3
BEQ (Mediator Pipe Capture):

Process ID
App Name
Time stamp

BEQ Messages
BEQ Messages typically have a fixed header followed by a variable length body which is based on the operation type, expressed as an op code.

TABLE 4
BEQ Fixed Header:

| | | |
|---|---|---|
| Length | Integer | |
| Session ID | ID | |
| Type of Session | Enum | before connect 1 |
| | | [negotiation] or session 6 |

TABLE 5
Variable information:

| | |
|---|---|
| Fields | |
| Function code | E.g. 05 |
| Bind Variable | Note - bind variables can typically be sent |
| | in both directions |

An example of a BEQ message sequence is as follows:

Application SQL Request: Select * from EMP where empno=:1

BEQ Messages:

03 05—SQL

07 bind value—will pass value of variable e.g. 135

or can do select into variable

in this case—07 would be in the response

### Logical Data Structures

The session object shown and described herein describes the logical view of the flow of data in the application—database session. It describes the session contest, such as user, application and time, and contains a list of SQL_context. The SQL_context object is a triple of SQL request, SQL response and the name-value set of Bind variables.

TABLE 6

| | | |
|---|---|---|
| User | | Based on context of the |
| | | Database connect function |
| Application | | Based on context of the |
| | | Database connect function |
| Time of session start | Timestamp | |
| SQL_Context | List | |

TABLE 7
SQL_Context:

| | | |
|---|---|---|
| Request | SQL Statement | |
| Response | Data Records | |
| Bind Variables | List of Name-Value Pairs | |
| Response Hash Value | Hash | Computed hash of the |
| | | response |

SQL Statements may be considered complete if the fields returned by the statement represent unique keys. A relaxed definition of completeness is that statements may be considered complete if the fields returned by the statement represent distinct rows with a high probability.

Packet Analysis Data Structures, according to an embodiment of the invention, are illustrated in FIG. 31.

### Repository Data Structures

The repository maintains the data structures to represent all sampled queries and their invocations.

Row Info: The row is the core element for analysis by the system shown and described herein. Rows may be described by the row info object. There may be instances of row_info objects every physical row that is retrieved during the data capture. The row info table is maintained in the system's repository database and part of the system's schema.

The row info object contains the collected and analyzed data for a specific row. It has a reference to each of the unique SQL statements that referenced it. The row is identified by its table and its unique row id, where the table is based on its description in the data dictionary. The row_info has a many to many relationship with the SQL_statement.

TABLE 8

| | | |
|---|---|---|
| Id | | Unique ID for this row |
| Unique Key | String | One or more columns that comprise the |
| Value(s) | representation | primary unique key |
| | of the unique key | |
| Table | Table name | Fully qualified table name based on data |
| | | dictionary [e.g. Scott.Emp] |
| SQL | List of references | Refers to all the SQL statements |
| Statement | | accessing this row for read or for write |
| Intrinsic rank | | Rank based on access counts |
| | | (0 = Never accessed; 1-100 based on |
| | | rank) |
| Ranks | List | List of ranks based on rules |
| Counter | Integer | Represents count of invocations |

The row is identified through its primary unique key in the production table.
1. By using the native unique key rather than the ROWID, there is no need to re-query the database to fetch the database ROWID. This is more efficient both in terms of production database hits as well as I/O overhead of the query/response.
2. The rowid is provided to identify the record over its complete lifecycle.
3. The database ROWID would not reflect the lifecycle of a record in a data warehouse. While most of the lifecycle follows the ETL (Extraction, Transformation, Load) lifecycle, rows can typically be deleted or reorganized.
4. The unique key may span several columns.
5. In the case of multiple unique keys, a single unique key may be chosen for the row info. If a query returns the other unique keys, then the query will be re-executed. An example would be a table with both identity number and mobile phone number, where both are unique keys.
6. There may be cases where there is no unique key. In this case, the rows may be indistinguishable and would map to a single row. For example, a table of names where the non-unique key is first name.
7. The production table schema information—the key information and uniqueness constraints is maintained by the data dictionary.

SQL_Statement: The SQL_Statement object contains the structure of the SQL statement and its bind variables. The uniqueness of an SQL Statement is determined by the SQL, level, type and parent and the bind variables. The SQL_Statement references the list of all recorded invocations of the statement.

TABLE 9

| | | |
|---|---|---|
| SQL Statement | Structure of SQL | Stored as text |
| Level | | Nesting depth |
| | | 0 - top level |
| Type | | Top level SQL |
| | | View |
| | | Inline view |
| Parent | Sql_statement reference | Reference to the SQL parent |
| | | statement |
| Invocations | List | Refers to list of invocations |
| | | of this statement |
| SQL Parsed | Reference to parsed | |
| | SQL table | |
| Bind Variables | Name value pairs | |
| Result set hash | Hash | |

The SQL_Parsed Table maintains a parsed representation of the SQL Statements. It may be used to maintain the list of what tables are in the query response, what columns and their order in the output and if there is a unique key

TABLE 10

| | | |
|---|---|---|
| SQL Parsed id | | |
| Tables | List of fully qualified | |
| | table names | |
| Columns | List of columns | Note - columns need |
| | in the response | to be listed in order of |
| | | appearance in the |
| | | response |
| Unique key_name | | |

Derived Information: There may be several relations that describe the usage of the production database. These relations express traits of the system or rows and objects that are derived from the database structures above.
Frequency of invocation—for an SQL statement, for a table, for a row
   By user
   By time
   By application
Last access invocation time—for an SQL statement, for a table, for a row, and for specific columns. The invocations may be sorted by
   By user
   By time
   By application
Read counts
   By user
   By time
   By application
Write counts
   By user
   By time
   By application
Bind Variables and Values
   By frequency
   By last access
List of the SQL statements that access each column

Ranking: Ranking is typically expressed as a table level object that expresses the relative access of a row or a column. The rank expresses the relative frequency of access of the object relative to the overall activity of the target system. The rank value is a normalized value on a scale of 0-99. Rank of 0 indicates the row has never been accessed. The intrinsic ranking is the ranking that is based on the number of read and write row accesses. Rankings and access counts reflect exclusion rules. For example, row accesses that are the result of invocations by a DBA application may not be counted if the DBA application or the DBA users are excluded in the exclusion rules.

Additional ranking data structures may be linked to the row_info. These rankings include configurable user-rule based rankings and “what if rankings”—which reflect the effect of repartitioning or record clean-up.

Rankings can typically be stored, loaded and restored using an XML exchange format referred to as a rank set. A rank set has the collection of row_info id's, the ranking, and a set of ranking rules, conditions and parameters. This allows “What if” ranking, where rankings can typically be compared based on different rules.

Repository Data Structures, according to an embodiment of the invention, are described in FIG. 32.
Rules may be used to configure the data collection and the analysis by specifying data to include or exclude in the processing. Rules may be maintained in the database as a list of exclusion criteria.
   Collection rules—used by the real-time collection to discard collection of packets. Collection rules may be system—wide in their scope. The exclusion criteria:
   User Id
   Application Name
   This is primarily used to prevent sampling of queries and re-execution by excluding packets originating from the ZPUser
When using time as an exclusion criterion in the real-time sampling—subsequent packets that are within the sample period may be lost or unusable if the connection packets for the session were excluded. It is preferable in most cases to set the exclusion rules at the packet analysis. For example, if a set of packets were excluded based on user id, and a change user command was executed, the change and subsequent packets will not be collected.
   Packet Analysis rules—used by the analysis to exclude the processing of messages in packet analysis. Sessions and SQL context records are not built from the excluded messages. The exclusion criterion:
   User Id
   Application Name
   Time Period
   Table (fully qualified name)
   Schema
   Ranking Rules—used by the ranking method in selecting sql invocations to consider in computation of row and other object ranking. The system can typically maintain different sets of ranking rules for multiple ranking computations. The exclusion criteria:
      UserId
      Application Name
      Time Period
   Table (fully qualified name)
   Schema

### Real-Time Components

Goals
Accurate capture of database packets, both client requests and server requests.
Minimal footprint and impact on the real-time flow of the Database client-server operations

Background
The real-time capture system integrates with the Multiprocess Database model. In this process model, Database spawns a dedicated process or alternatively uses processes from a process pool to handle client application connections.

Real Time Collection Architecture, according to an embodiment of the invention, is illustrated in FIG. 33.

Components

The architecture may be similar to the intercepting filter enterprise pattern. This pattern provides a solution for pre- and post processing requests and responses. No changes in existing client or server code are made.

System Manager: Typically, the system manager loads configuration and run-time parameters into shared memory for control of the sniffers, mediators and packet depot. It monitors the database active sessions by querying V$, and sets exclusion rules for the sessions for the sniffer and mediator.

Interface: Shared memory

“Sniffer”: Typically captures relevant TCP packets, attaches a time stamp and context info, and writes to the pipe to the packet depot. The sniffer is typically a user-level process, and uses libpcap to invoke kernel level network filtering functionality. Packets may be captured based on configuration parameters—destination host and port for the Database listener.

Interfaces: UDP socket to the packet depot

Shared Memory—reads parameters and filter exclusion lists.

Mediator Process: Typically captures relevant database packets, attaches a time stamp and context info, and writes to the pipe to the packet depot. Spawned by the Database (e.g. Oracle) Listener through the process spawning model

Interfaces:

Inbound pipe interface to client requests

Inbound pipe interface to Database server response

Outbound interface to client response pipe

Outbound interface to Database server requests pipe

UDP Socket to the packet depot

Shared Memory—reads parameters and filter exclusion lists

Packet Depot: Typically, the packet depot is a component that records the captured packets. It runs in as a process on the target system. UDP Socket listener, records packets from the mediators or sniffers to files. Executes capture filter rules, such as exclusions based on host/user name, SQL type and database instance on the server. Listens on pipe for control messages. Records data in a file per session, in a local file directory defined in the configuration. New files may be opened when the current file or a session reaches a size limit.

Interfaces:

The packet depot is a pipe listener on a well-known pipe for incoming packets. Additionally, it listens to a pipe for control messages.

Scenarios:

Remote Network client over TCP/IP

Local Client over TCP/IP

Local Client over Pipes

Life Cycle and State Model

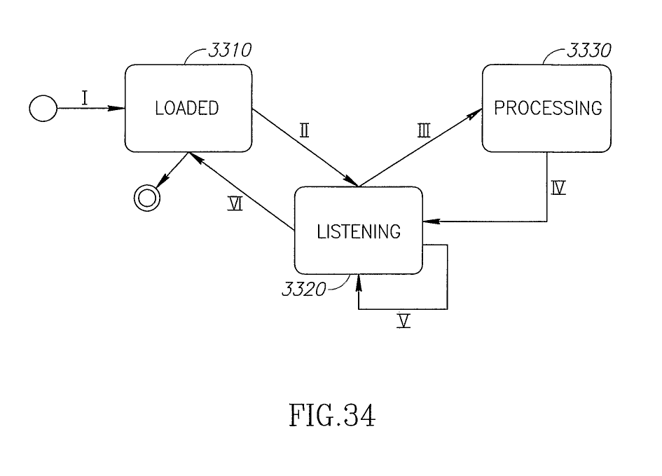

Sniffer—Typically, the sniffer process is a user—mode process that collects the client request and database response packets via the TCP stack. There is one sniffer process per server. A state model for the Sniffer process, according to an embodiment of the invention, is illustrated in FIG. 34. The sniffer state model illustrated in FIG. 34 may for example be as follows:

The sniffer process is created at system start up and in the loaded state. In the loaded state, the sniffer process is loaded but it is not yet recording packets. The sniffer process is activated and is in the listening state. In the listening state, the process receives packets based on the TCP/IP filter pattern. When a relevant packet is received, the sniffer transitions to the processing state. In the processing state, the sniffer records the packet and associated context information to the pipe. On completion of writing the packet to the pipe, the sniffer returns to the listening state. When the sniffer is in the listening state and it receives packets from sessions that are on the exclusion list—the packets may be discarded. The sniffer can typically be set to return to the loaded state and to cease receiving packets. The sniffer is shut down at system shutdown and by command.

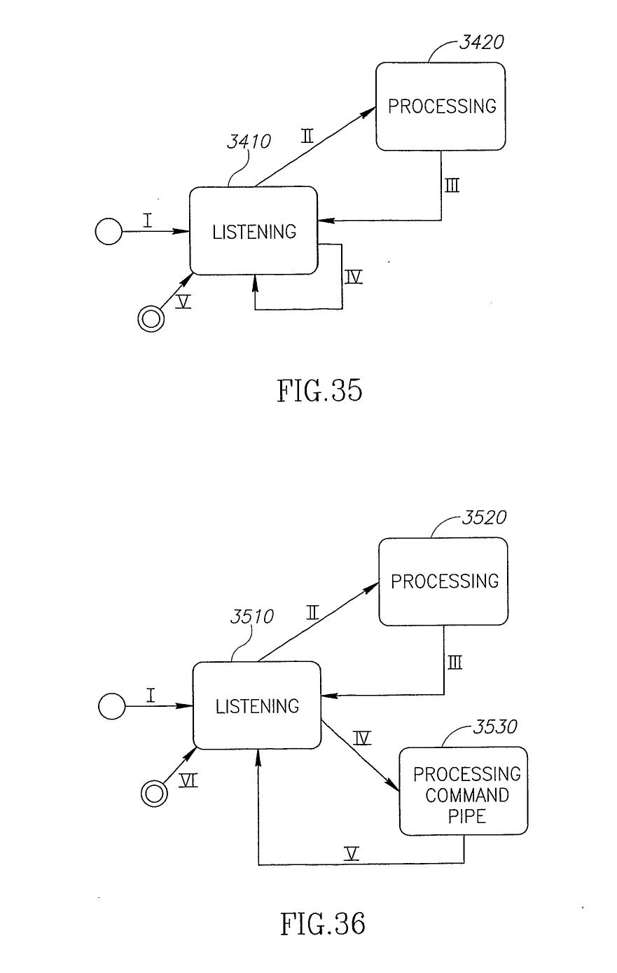

Mediator—Typically, mediator processes may be spawned through the Database process model, and their lifecycle is determined by the lifecycle of the application client session. One mediator process state model provided according to an embodiment of the invention, is illustrated in FIG. 35. A mediator process is spawned by the Database process model and the mediator process is in the listening state. In the listening state, the mediator receives requests packets from the client and response packets from the server. When a relevant packet is received, the mediator transitions to the processing state. In the processing state, the mediator records the packet and associated context information to the pipe. On completion of writing the packet to the pipe, the mediator returns to the listening state. The mediator will discard packets in the listening state if the client application process is in the process exclusion list. The mediator process is terminated up on termination of the session.

Packet Depot—Typically, the packet depot process consolidates all of the recorded packets. It receives these packets through a pipe. There is one packet depot process per server. A State Model for the Packet Depot, according to an embodiment of the invention, is illustrated in FIG. 36. The packet depot process is created at system start up in the listening state. In the listening state, the packet depot listens for pipe messages on the packet pipe and on the command pipe.

When a relevant packet is received on the packet pipe, the packet depot transitions to the processing packet state. In the processing state, the packet depot determines this application session of the packet and writes the packet and associated context information to the session file.

On completion of writing the packet to the file, the packet depot returns to the listening state. When a relevant packet is received on the command pipe, the packet depot transitions to the processing command state. In the processing state, the packet depot executes the specified command. On completion of writing the packet to the file, the packet depot returns to the listening state. The packet depot is shut down on system shut down and by command.

Collaboration Diagram for Key Flows

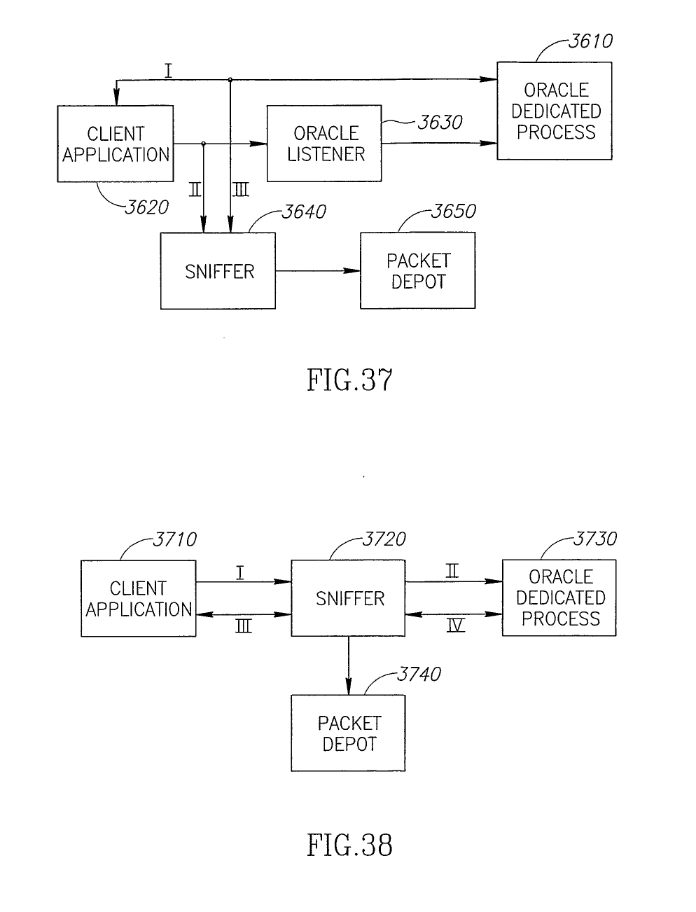

FIG. 37 shows a preferred process collaboration model for a network client session in the Database Multiprocess model. The client requests a connection with the Database (e.g. Oracle) Listener. The connection request packets may be recorded by the sniffer. After establishment of the session, subsequent packets between the client application and the database process may be recorded by the sniffer.

A mediator based model, according to an embodiment of the invention, is illustrated in FIG. 38. FIG. 38 shows a process collaboration model for a local client session in the Database Multiprocess model. The client initiates a Database session, which results in a Mediator process being spawned. The Mediator spawns the default Database (e.g. Oracle) process. The mediator listens for client packet on the client pipe, and returns responses to the client via the pipe. The mediator listens for server responses from the Database process via the pipe, and send client request to the server via the pipe.

Performance: Typically, in the Mediator model, there is additional overhead for the Mediator to read the packets from the pipe, process the packets and write them to the client or server pipe, as compared with the sniffer model. The extent of the performance impact, in end-to-end response time, will depend on the volume of the returned records. In the sniffer model, there is lower overall performance degradation since the capture is through network packet filtering at the level of the kernel TCP stack.

Resource Usage: Typically, in the mediator model, there is a mediator process associated with each client session. Processes have associated scheduling overhead and require significant resources. However, the overhead of process creation is a small part of the creation of a Database connection and may not add end-to-end delays to the connection process. In the sniffer model, there may be fewer resources per server. The packet depot requires significant file storage resources for writing the packets.

Failure Recovery: In the Mediator model, an error that would cause the failure of a mediator process would result in the loss of an application client session. All other sessions may not be effected. The client may receive a Database error that the connection has failed. The application may handle this error the same way that it handles any failed connection. In the sniffer model, a failure of the sniffer process would eliminate packet recording of all processes. As a user-level process, it may not comprise the tcp stack. The sessions would be recorded as non-closed sessions.

Re-execution Overhead: Typically, since the real time capture by the mediators and sniffers will capture all database traffic, the analyzer queries and re-execution of captured SQL by the analyzer and executor will also be captured. This will cause significant network overhead, pipe overhead, storage space, and cause double processing by the packet analyzer. The manager determines the session ID of the sessions by polling a V$ table. The manager then sets up an exclusion list of session id's in shared memory. The sniffer and mediators do not capture packets from sessions in the exclusion list.

Properties of the Analysis shown and described herein preferably include:
Extensible and configurable functionality: The analysis functionality may be configurable by the user. The user may be able determine what analysis functions may be required, how the analysis will run [schedule, resources] and what rules to apply.
Minimal footprint and impact on the real-time flow of the Database client-server operations: The analysis typically accesses the target database for processing.
Space efficient processing of data: Provision of storage space for building its intermediate data structures.
Distributed processing: The analysis processing may be partitioned to allow distributed processing for optimal balancing of resources.

The analysis subsystem comprises a set of components, where each component is responsible for a stage of the analysis. These components process the packet data in series, and work as a pipeline of consumers and producers through queues. This approach is similar to the pipeline design pattern. In the pipeline pattern, each thread completes a portion of a task, and then passes the result to the next thread. The advantages are the simplicity of the model and low overhead of synchronization. The disadvantages of the model may be the dependency of the throughput on the slowest stage. In the case of the analysis subsystem, throughput is less significant than the ability to balance the database hits on the production database. Additionally, the use of persistent queues allows for robust failover. The components may comprise some or all of the following:
InitialRankBuilder: The InitialRankBuilder builds repository data structures based on the internal tuning information in the V$ system tables (http://www.ss64.com/orav/v$SQL and other tables). This component is run upon system set up, for building initial data structures and recommendation of selection of tables for capture.
Analysis manager: The analysis manager controls the process context for the analysis, and drives the initial data flow, and registers queues and resources. It is responsible for set up and launch of the components and controls the task execution. It is responsible for the management, monitoring and configuration of the analysis.
Packet Analyzer: The packet analyzer is started by the Analysis Manager. It typically performs the following tasks:
   Processing of the raw_data_packets from the packet depot
   Construction of the session
   Construction of Repository data
   Queues sessions for query analysis.
   Database raw data for responses may be structured as a vector that identifies the fields, and then a sequence of column data. Data that is repeated from previous rows is not repeated in the vector.
SQL Analyzer: The SQL analyzer builds the core repository data structures from the session and SQL_context. These data structures include the SQL_statement and SQL_invocation. If the SQL Analyzer finds a full match with an existing SQL_statement—including the response hash, it only has to create a new invocation record. If the SQL statement is new, the SQL_analyzer determines if the query has a unique key and if it requires re-execution. If no re-execution is required, the statement and response may be sent to the query loader for analysis. Otherwise, the query analyzer queues SQL_statements to the executor for resolution of special cases. The component rewrites the SQL statement to retrieve the unique keys from the response records of the query. The rewritten SQL is queued for evaluation.
Query Loader: The query loader handles the case of new SQL statements with a unique key that do not need re-execution—response analysis and build row_info records
Executor: The executor is called to resolve incomplete SQL Statements where incomplete is the sense that is defined in terms of uniqueness of the fields in the returned records. It is also called to resolve other special cases as described below. The Executor is driven by an input queue of SQL_statements. The component rewrites the SQL statement to retrieve the unique keys based on the SQL statement. The rewritten SQL is queued for evaluation.
   Select * from emp, dept
      →sqlid, select eid from emp
      →sqlid, select did from dept
Row Collector: The row collector evaluates rewritten SQL from the query analyzer and the executor, retrieves the unique key values and updates the SQL_statement references to the row_info records. The execution of SQL evaluation is configurable to give the least impact on the production system.
Ranking: The ranking component computes the row-level rank. The ranking component runs on demand or on schedule.
Data Dictionary: The data dictionary provides an interface to all schema, meta-data and table statistics in the database. The analysis components can typically query the data dictionary for a description of database objects such as tables and columns. For example, the data dictionary is responsible for providing information on the uniqueness properties of columns. The data dictionary is also responsible for handling schema changes.

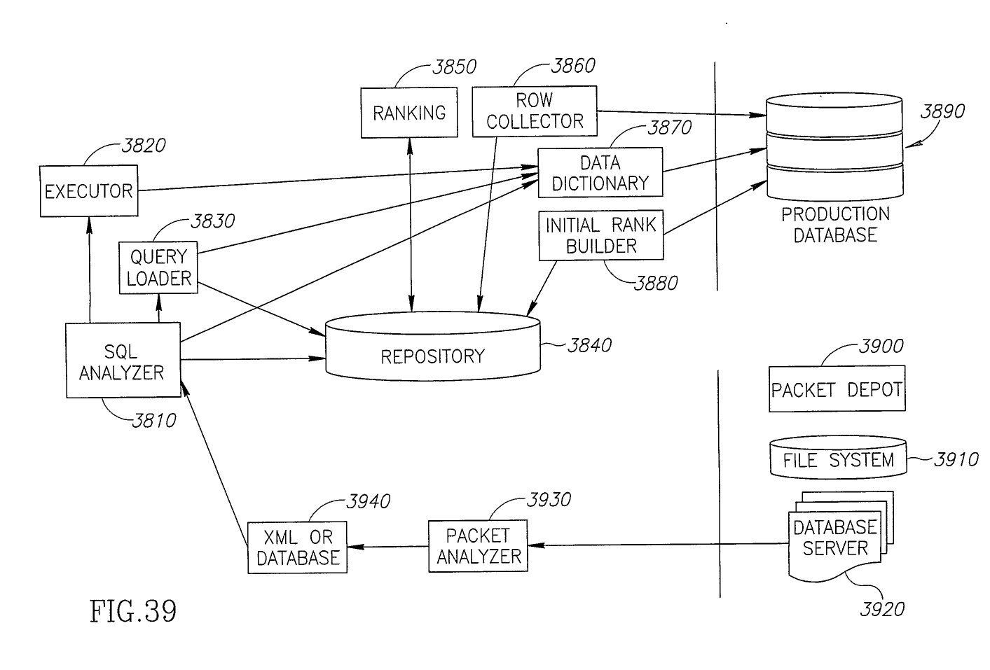

Analysis components, according to an embodiment of the invention, are illustrated in FIG. 39. Additionally, the analysis subsystem may maintain a set of configuration parameters and analysis rules as described above.

The components run in the context of a pool of worker threads. The mechanics of how each task will be run is decoupled from the submission and the task logic. An example of such decoupling is the Java J2SE 5.0 java executor model, which enables different execution models for a runnable component—including thread pooling and scheduling—without a need for explicit code in the task component.

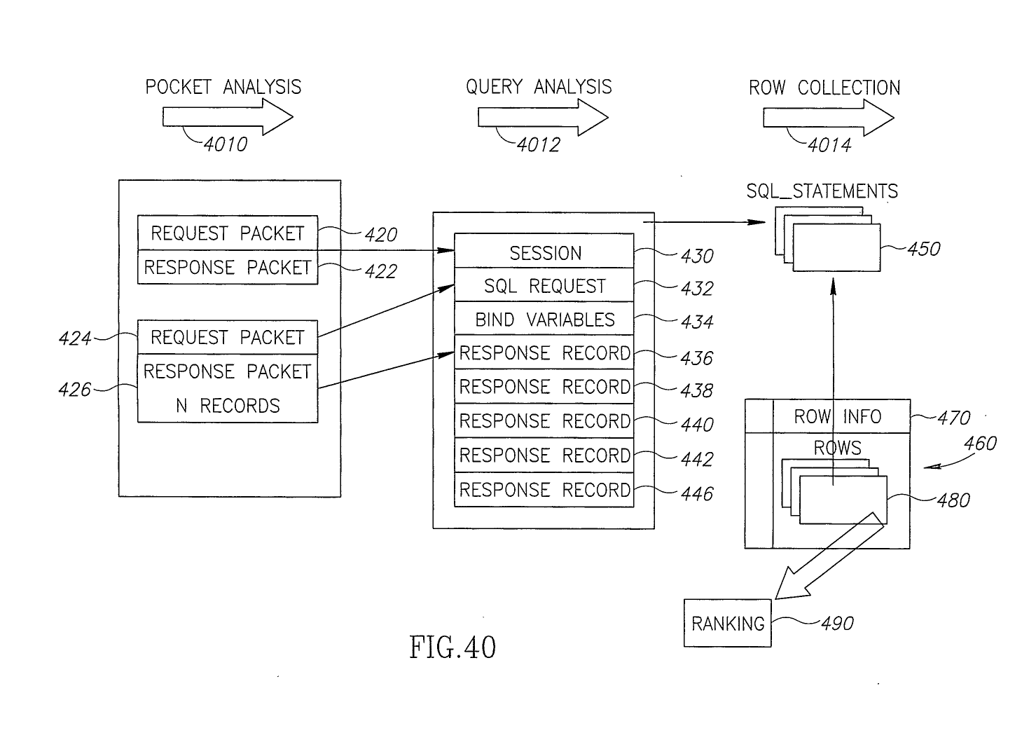

The Analysis, a high level flow diagram of a certain embodiment of which is illustrated in FIG. 40, is implemented through a pipeline flow of data through the components. The pipeline is preferably operative to process the raw packets into row info and SQL statements. Typically, the analysis can only be performed on returned records since these may be the records that are sampled. There is no information on rows used in the execution of SQL statements but not returned, such as in Join statements.

Construction of Initial Ranking: The Analysis subsystem constructs an initial ranking which can typically be constructed from the V$ Database tables or other sources, such as Business Intelligence applications or logs. The InitialRankBuilder constructs the Repository Data Structures from these sources. The V$ tables may be used by the Database for accumulation of performance and tuning data. For example, the V$SQLAREA, joined with V$SQLTEXT, V$SQL and V$SQL_BIND_CAPTURE can typically be used to construct the SQL_STATEMENT data structure in the repository. The V$ tables maintain an aggregate number of executions for each SQL statement. The SQL is rewritten to retrieve unique key values and executed, and the repository row_info references may be updated. V$ may collect statements that are Database Parallel Execution statements, which are not legal top-level SQL statements. These may be the result of Database's execution of SQL and contain special internal hint field. Since the parent SQL is parsed and in V$—so these parallel statements may be ignored. The exclusion rules for users and tables can typically be applied at this stage.

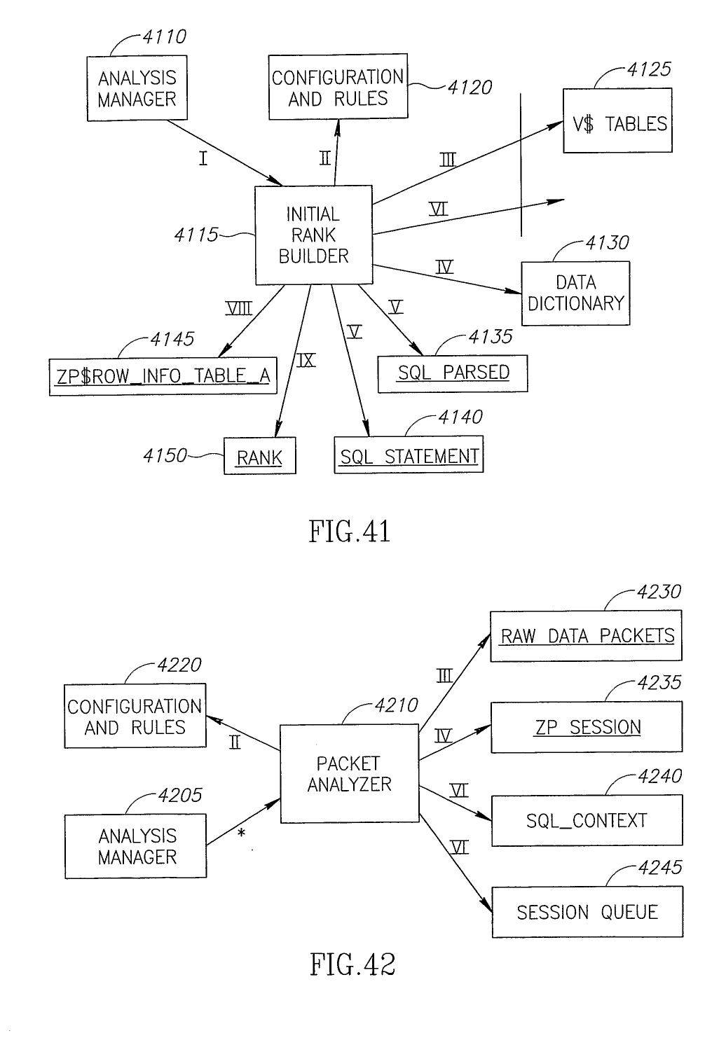

A collaboration diagram for Initial Ranking, according to an embodiment of the invention, is illustrated in FIG. 41 and is described in the following Method A. Method A typically comprises the following steps as indicated by Roman numerals I-IX in FIG. 41:
1. The analysis manager invokes the initial rank builder
2. The initial rank builder loads configuration information such as the list of sampled tables and the analysis exclusion rules
3. The initial rank builder retrieves the list of executed SQL statements from the production data warehouse V$ tables
4. The initial rank builder consults the data dictionary to extract the table and unique key information for each SQL statement
5. The initial rank builder constructs SQL_statement and SQL_rank objects
6. The initial rank builder executes the SQL statements
7. The initial rank builder constructs the response hash
8. The initial rank builder constructs the row info in the row info tables
9. The initial rank builder constructs the initial ranking from the V$ information

Packet Analysis: Packet analysis is the first step in analysis of the real time data. A Packet Analyzer instance is assigned packets from the packet depot by the analysis manager. The packets may be processed e.g. as shown in the packet analyzer collaboration diagram of FIG. 42. A preferred method useful in conjunction with the apparatus of FIG. 42 is described in the following Method B. Method B typically comprises the following steps as indicated by Roman numerals I-VI in FIG. 42:
1. The analysis manager invokes the packet analyzer in a thread context to process the next session of raw packets from the packet depot. This is done iteratively as long as there are raw packets.
2. The packet analyzer loads the configuration information including analysis exclusion rules
3. For all of the raw packets in the file
4. Create a new session
   i. Apply collection level exclusion rules
   ii. Build ZP_session
5. For all of the packets in the session
   b. Apply analysis level exclusion rules to the packet
   c. Request Packet
      i. Build new or add to existing SQL Context
      ii. Delete packets from the packet depot
   d. Response packet
      i. Add to the existing SQL Context
      ii. Build the response hash
      iii. Delete packets from the packet depot files
6. Queue the session for query analysis and clean up the completed packet depot session files

Query analysis builds SQL_Statement and SQL_Invocation data structures in the repository. Query Analysis instances process ZP_Sessions and their associated SQL_Context. The Query Analysis initially attempts to determine if there is a match for the SQL Context with existing SQL Statements in the repository. If there is a match, the Query Analysis only adds an invocation record. This approach improves the scalability of the analysis, since as more queries are captured, there will be more existing SQL statements in the repository to match.

Method C is useful in implementing the above-described features and may include the following steps:
1. The analysis manager gets the next session from in the session queue and invokes the query analysis in a thread context.
2. Get the next SQL_context in the session in a loop
3. SQL Statement matches an existing sql_statement in the repository?
   match text, bind variables, hash response
a. create new invocation record from the zp_session
b. clean up ZP_session and SQL context and loop to #2
4. Else no existing match—create a new SQL_Statement
   a. Identify top level tables using the data dictionary—and builds parsed_sql
5. Create new invocation record with the session context information
6. Does the SQL_statement require re-execution?
   a. Is the number of returned records is small
      [<than a threshold relative to the table size]
   b. Is this a special case—handled by executor
      i. Very fast SQL
         Re-execution is less intensive than analysis, despite the database hit on the production table
      ii. Small Table
      iii. View
         Views may be analyzed as a sub statement
      iv. Synonym
         Note: Can be recursive
      v. DBLink
         Database P1 is accessed from P2 and P3. There is no direct access to P1—but heavy access through DBLink. DB Link does not use the same protocol as Database clients But can typically be sniffed by TCP sniffer
   c. Queue for executor
7. FOR Each Table referenced in the query:
   a. If the returned fields are unique and the fields are returned then the unique key is chosen for the row_info
      Check with the Data Dictionary for properties of the field
shortest unique key from the fields sent
explicit or implicit unique constraint
use database key statistics and distribution [parameterized].
For example: the error level would how many records map to the same key value—such as phone number—how many people have the same phone number.
   b. Then Queue for the query loader
8. Clean up ZP_Session, SQL Context, loop to #2

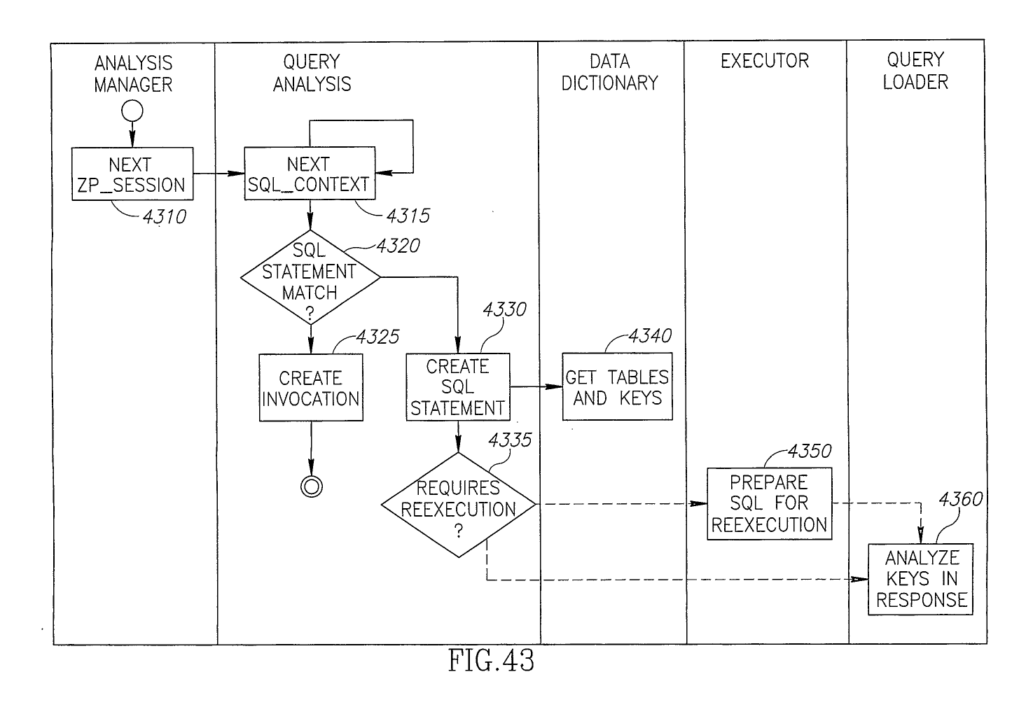

An Activity Diagram for Query Analysis, according to an embodiment of the invention, is illustrated in FIG. 43. The query loader builds the row info for new SQL statements from the response fields both for statements that do not require re-execution as well as for the results of re-execution. Method D is useful for this purpose and typically comprises the following steps:
1. The analysis manager gets the next SQL statement from the query loader queue and invokes the query loader in a thread context
2. For each record in the response
   For each table in the SQL_statement::
retrieve the unique key from the returned fields using the data dictionary
for the returned records: if a row exists in the row_info instances that match-
   i. Update the reference to the SQL statement if the row_info does not exist—create a new record and update the reference to the SQL statement

Executor: In these cases, the query is re-written for re-execution by the executor in order to return the unique key values, e.g. as in the following method E which may comprise the following steps:
1. The analysis manager gets the next SQL statement from the executor queue and invokes the query loader in a thread context
2. Rewrite SQL using the rewriting rules:
   a. For each top-level table
      i. Replace fields with unique key of the table in the statement using the data dictionary
   b. Views—for one level—replace view with the definition query of the view
   c. Apply bind variables
3. Queue the rewritten SQL and the SQL_statement id for row collection

Row Collection: The collection component processes the rewritten SQL produced by the executor, and retrieves the unique keys, and updates the row info-sql_statement references. Row collection is decoupled from the executor to allow the setting of the schedule and priority for execution of SQL on the production database. Row collection allows batch updates of the repository for higher efficiency. Method F is useful for this purpose and may comprise the following steps:
1. The analysis manager invokes the row collection component
2. The row collection component runs in a scheduled thread context
3. For each rewritten statement
   a. Row collection executes the rewritten SQL statement
   b. The unique keys may be extracted for the response records
4. Queue for query loader

Ranking may be performed on a configurable schedule or on demand by the Ranking component. Ranking may be computed from the invocation statistics for each row_info record. In addition to the overall ranking based on invocations, the ranking can typically be computed using exclusion rules, and reported as a function of user, time periods and applications. Ranking may be system-wide.
1. Ranking may be invoked on demand or as a scheduled task
2. Ranking computation:
   a. Ranking component collects the count of sql_invocation for each row_info record, and creates normalized ranking records for each row_info
   b. Ranking may be relative to the total of all of the accesses in the system

Ranking preferably takes into account both read and write access. There may bean intrinsic ranking, which may be the normalized rank based on total number of access, as well as user-definable ranking. The user definable ranking applies the ranking exclusion rules. These rules may include:
a. Users [database or UNIX]
b. Program
c. IP address/computer name
d. Time period
e. Table
   User-definable ranking uses weighting and user driven rules
Select count(*) group by SQL from . . . where exclusion/inclusion−need to then multiply by weighting factor . . .

For example, the accesses by a particular user can typically be given a higher weight to signify that those accesses have a stronger contribution to the data being considered significant.

An implicit weighting that may be used in ranking may be aging. The contribution of accesses to ranking may be aged over time by a factor to give significance to recent accesses.

Clustering and Pattern Analysis: Cluster analysis and pattern analysis of the data may be used to identify trends in data usage through data mining. For instance, it may be important to identify independent columns in the data that may be predictive of hot or cold data. For instance, in a table with a unique key and a column color—this method identifies if the value of color predictive of the row usage.

Architecturally, the clustering and patterns analysis use the row_info, sql statement and invocation data to identify field values of the row_info that may be predictive of usage. The clustering and pattern analysis will run on demand or according to a schedule, similar to the ranking. The data structures for representation of the pattern will be determined in a future version.

Analysis Rules for SQL Statements: The SQL_statement may be analyzed recursively to identify the target tables. These table appear in the from clause of the select statement, or in nested select statements in other clauses of the parent.

Select Statements: Select statements may be considered as read accesses to rows. Select statements may be analyzed by the query analyzer. If the statement belongs to a group of special cases, or if the fields in the select are insufficient to uniquely determine the returned records, the statement may be sent to the executor.

Special cases may include: Very fast SQL, Small Tables, Views may be analyzed as a sub statement, Synonym, Can be recursive.

DBLink: Database P1 may be accessed from P2 and P3. There may be no direct access to P1—but heavy access through DBLink. DB Link does not use the same protocol as Database clients, but typically can be sniffed by TCP sniffer

Processing a Group By—aggregation—includes removal of the group by statement and analysis of all of the rows in the where clause.

In the case of a full table scan—most or all of the rows of a table may be accessed. For example, consider a fact table with 10 M records. If the response has 3 million records, identification of hot records may not be significant. However, the processing of these records may be important in order to identify “cold” records that are not accessed at all. The only case where this could be ignored would be in a full table access with no Where clause where every record must be accessed. Additionally, in the Join of a large set and very small set, the result would still have a very large number of records [e.g. 800000 emp in dept 4]

E.g. Select t1.c1 from t1,t2 where t1.c1 in (select c3 from t4 where c5=12) AND t2.c2=4 and t2.c3=t1.c3

All of the smaller set may be accessed.

While updates are not typically part of the ETL process in Data Warehousing, Updates may be recorded as write access. In order to analyze the update, the statement may be rewritten as a select statement and sent to the executor. The update values may be used to identify the unique key value.

update x from y where y.a=z.b values ( )

Stored Procedures: Analysis of Stored Procedures may be critical in many systems. Ignoring row accesses by stored procedures can typically result in “false negatives”—rows being identified incorrectly as never being accessed. The ability to sample the stored procedures will depend on the real time component being able to intercept the flow of request/response data from the spawned process. These packets may be correlated with the parent SQL request/response from the client.

Triggers: Triggers are not typically used in a data warehouse setting. The trigger updates could potentially be sampled by monitoring the spawned process that the trigger generates.

The Front End typically has some or all of the following characteristics:
Web-based front end for user interaction
   Brower will be client
   Interaction through HTML-based web pages
Reports may provide effective visualization of the status of the data usage
Separation of logic, data structures and presentation
   Easy to customize look and feel

Patterns: The front-end may use common web front end patterns as a solution framework.
Model-View-Controller Type II
   Dispatcher View—uses a Front Controller—and helper objects to separate the page flow and navigation and handle rendering of dynamic content
   Dispatcher
   Business Delegate—use of action beans to reduced coupling between front end and the business logic
Business Delegate and Adaptor—the action beans provide an encapsulated interface using an XML adapter, and decouple the service layer [model] and presentation layer [view]
Data Access Objects—Data Access Objects encapsulate access to persistent storage. Access to the repository from the Front End for display and for reporting uses DAO for data access.

Context: Front End components may run in the context of a J2EE Web Server. This server supports the J2EE Servlet API, and provides thread management, connection management, session management and resource management. This environment includes technologies such as:
Java Server Pages [jsps]—used for dynamic content pages
Servlets—used to implement the front controller
Tag Libraries—libraries of reusable tags for rendering data elements in the JSPs
JMX—Java Management Extensions framework for management and monitoring components.
Reporting Engine—a COTS or Open Source engine for display of tabular data and graphs based on a configuration file
   Components may include:
Static Content: Static content will be fixed HTML and graphics used in the presentation. There may be several language or custom version of the static content.
Dynamic Content: The dynamic content may be provided by Java Server Pages [JSPs] The JSPs use Tag Libraries and Java Beans to access and render data objects. The JSPs may use Java applets as presentation widgets to produce a richer presentation than HTML.
Servlet Controller: The Servlet Controller handles the navigation and page flow, and dispatches the user requests to Action Beans that encapsulate the back end logic for user requests. The page flow may be maintained in an XML configuration file, giving separation of the page flow, the presentation JSPs and the servlet code. This is similar to the architecture of the Apache Struts framework or the Java Server Faces [JSF] framework.
Action Beans: The Action Beans encapsulate the functionality of related use cases and provide an interface for the presentation layer, using data objects that may be implemented in XML. A typical Action Bean encapsulates the functionality of a page or a screen and its associated methods.
Report Generation: The report generation component runs after the analysis to build the reports. The component builds report tables. These tables may be used by the front-end controller and view to produce interactive HTML reports, and by report generation engines to produce other static reports such as PDF. The report generation component uses Repository Beans as data access objects to access the Repository data structures [row_info objects, SQL_statements, invocation records]. An example of a reporting engine for off-line report production is the Open Source Jasper Reports framework.
SQL Generation: The SQL Generation component produces SQL for execution of data warehouse re-partitioning, clean up and other maintenance tasks. The component uses the Repository Beans to access the repository data structures.
Alerting: The alerting component allows retrieval of configurable alters generated by the system of the present invention. Alerts may be generated by all of the components in the system. An example of a Warning alert would alert the user when certain (user defined) conditions are met (e.g. usage in a table falls below a certain percentage). The Alerting component runs a set of rules against the repository to generate data alerts and capture alerts.
User Management: The user management component maintains the user list, the user authentication credentials, and may be integrated with the application server J2EE security.
Management component: The management component encapsulates the management functionality. This includes the interfaces to run time JMX based monitoring of Analysis and Real-Time components, and the interfaces to system-wide configuration and parameters as well as the interface for management of rules.
Repository Bean: The repository beans encapsulate the access to the repository and function as data access objects. They provide access to the row_info objects, the ranking tables, the SQL_statements and the invocation records.

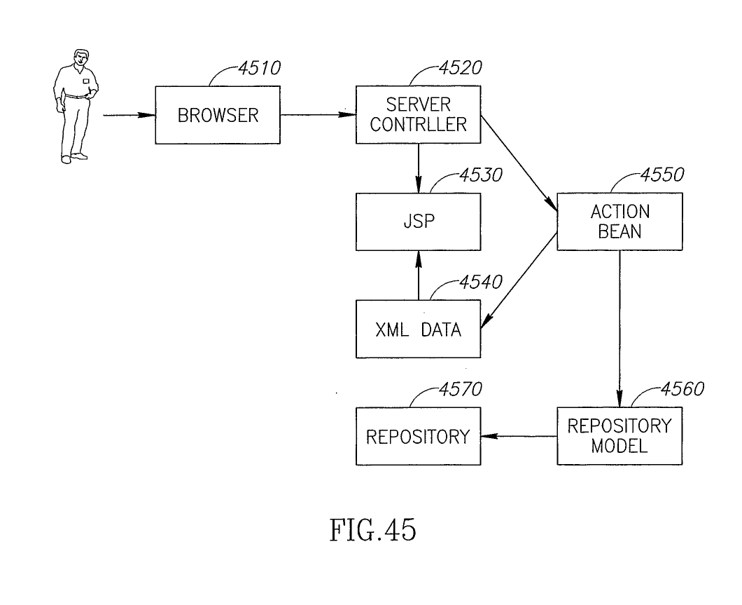

FIGS. 1 and 45 illustrate Front End Components according to an embodiment of the invention. Method G is useful in conjunction with the apparatus of FIGS. 1 and 45 and typically comprises the following steps:
1. The user selects a page in the browser that returns the status of the analysis.
2. The selection may be sent as an HTTP request to the Servlet.
3. The servlet calls the action bean for the page.
4. The Action bean calls the repository model.
5. The repository model retrieves the report data from the repository.
6. The action bean returns the report data as XML to the servlet context [context of the current request].
7. The servlet controller determines the next JSP and forwards the appropriate URL, along with the XML data that is returned.
8. The JSP uses the XML data to construct the table.

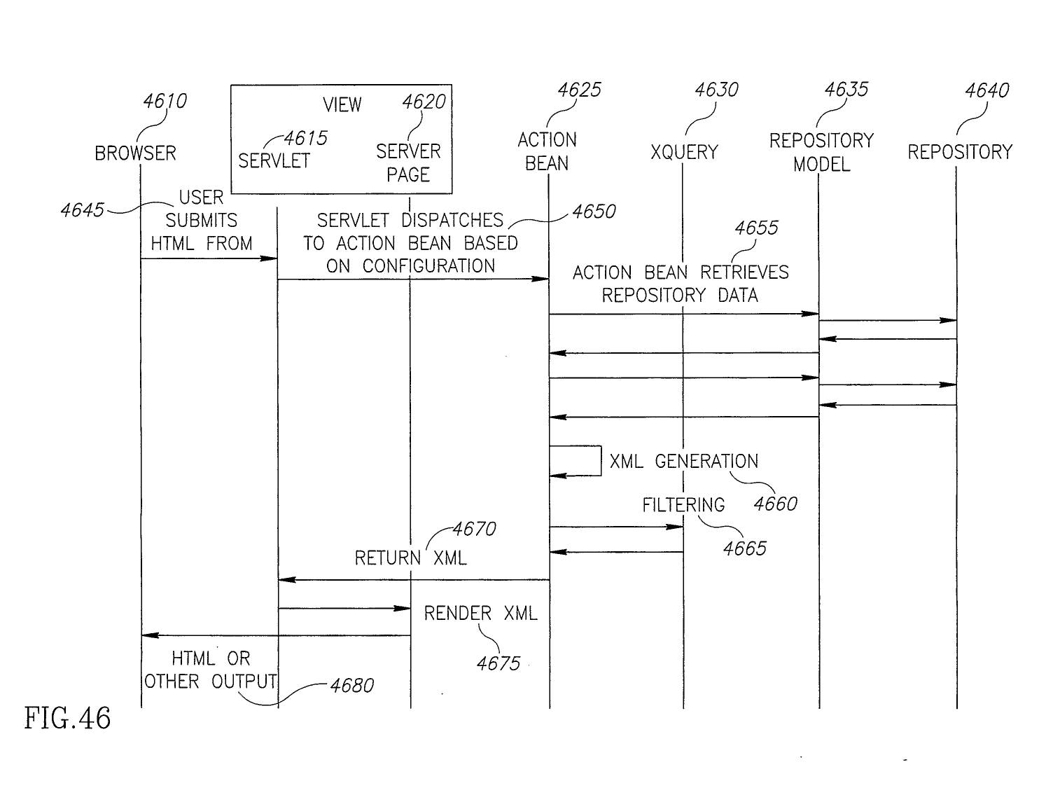

A Front End Components Sequence Diagram, according to an embodiment of the invention, is illustrated in FIG. 46.

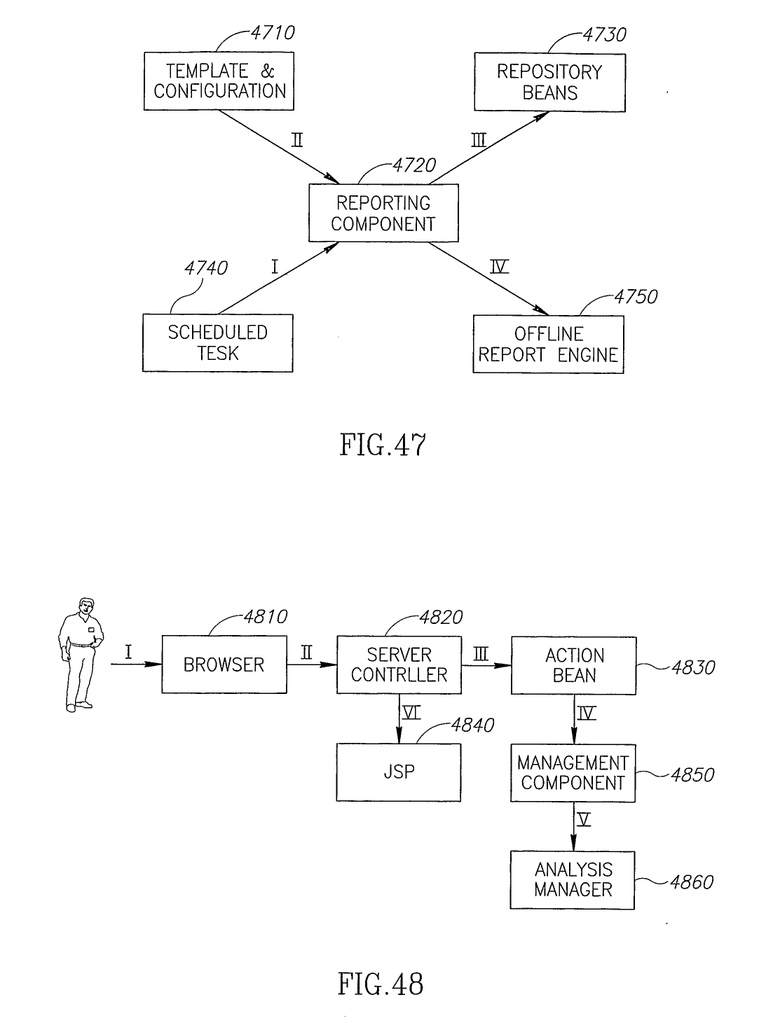

A collaboration diagram for report generation, according to an embodiment of the invention, is illustrated in FIG. 47. The following Method H is useful in conjunction with the apparatus of FIG. 47 as indicated by Roman numerals I-IV in FIG. 47 which may correspond respectively to the following steps:
1. A scheduled task provides a process and thread context for the report generation. The schedule may be set by system configuration.
2. The reporting component loads the report template and configuration parameters.
3. The reporting component generates reporting tables using the repository beans.
4. The reporting component can typically generate a packaged set of reports, such as PDF for printing and email purposes and updates the front end configuration with the path of the new report. This is typically done using an external reporting package that accesses the reporting tables.

A collaboration diagram for status of Analysis, according to an embodiment of the invention, is illustrated in FIG. 48. The following Method I is useful in conjunction with the apparatus of FIG. 48 as indicated by Roman numerals I-VI in FIG. 48 which may correspond respectively to the following steps:
1. The user selects a page in the browser that returns the status of the analysis.
2. The selection may be sent as an HTTP request to the Servlet.
3. The servlet calls the action bean for the page.
4. The Action bean calls the management component.
5. The management component interrogates the Analysis Manager in the Analysis System and obtains the status.
6. The servlet controller determines the next JSP and forwards the appropriate URL.

The collaboration model for other management activities, such as configuration and control, may be similar. The Management component encapsulates the interfaces for configuration and for component control.

Alerts: Alerts in the system allow components to request user attention. There may be several types of Alerts:
System Alerts—System Alerts indicate the presence of a system event requiring user attention. An example of these kinds of alerts is system errors of different severity which require the user to perform corrective action. These kinds of alerts may be actively generated by component code. An example of these kinds of alerts would be to alert the user of low available disk space.
Data Alerts—Data Alerts indicate a condition in the analyzed target DB. The Alerting component runs a set of rules against the analysis results, and generates an alert when the conditions of the rules are met. For example, an alert would be generated when the data usage distribution deviates from the required model. Such an alert could indicate a condition such as 95% cold data in a given table.
Capture Alerts—Capture Alerts indicate a condition in the selection of data capture rules. Typically, this is meant to show inefficiency in the rules. An example of a capture alert would be an alert that indicates that capture is enabled on a very small table with less than a threshold number of rows.
   Alerts may be assigned severity—such as critical, warning or informational. The severity level describes the level of action the user may take to address the alert:
Critical—The system or the Target database have met a critical condition that prevents normal functioning of the system. For the system to resume normal operation, action must be taken immediately.
Warning—The system or the Target database have met a condition which requires user action in order to prevent failure of the system
Information—The system or the Target database have met a condition that may be brought to the attention of the user during the course of normal operation.

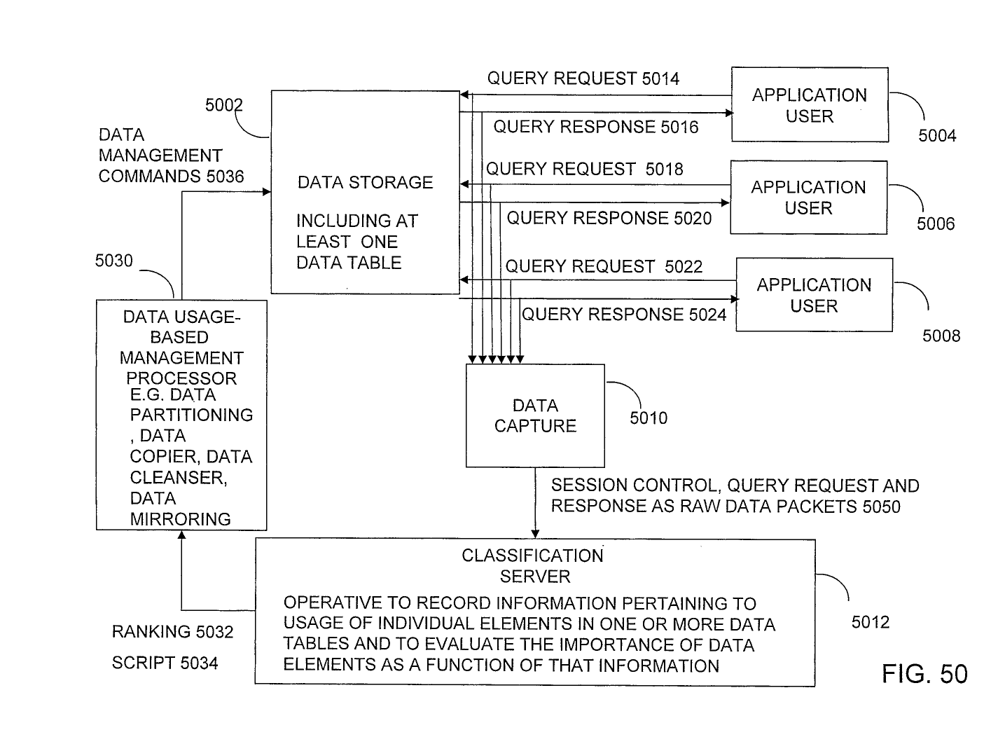

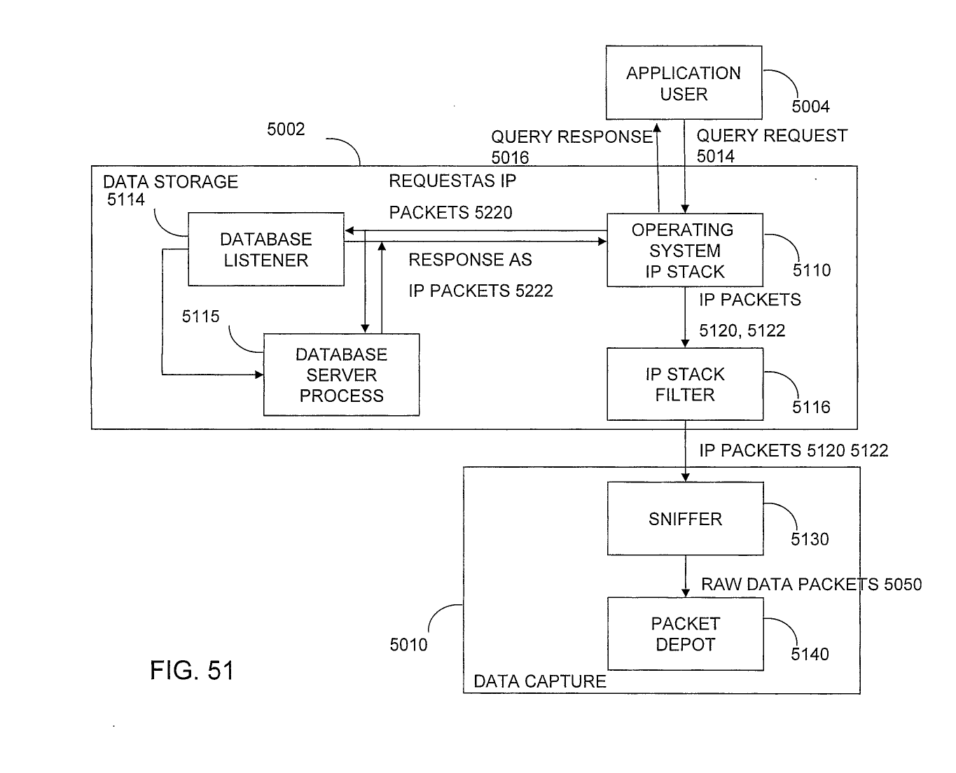

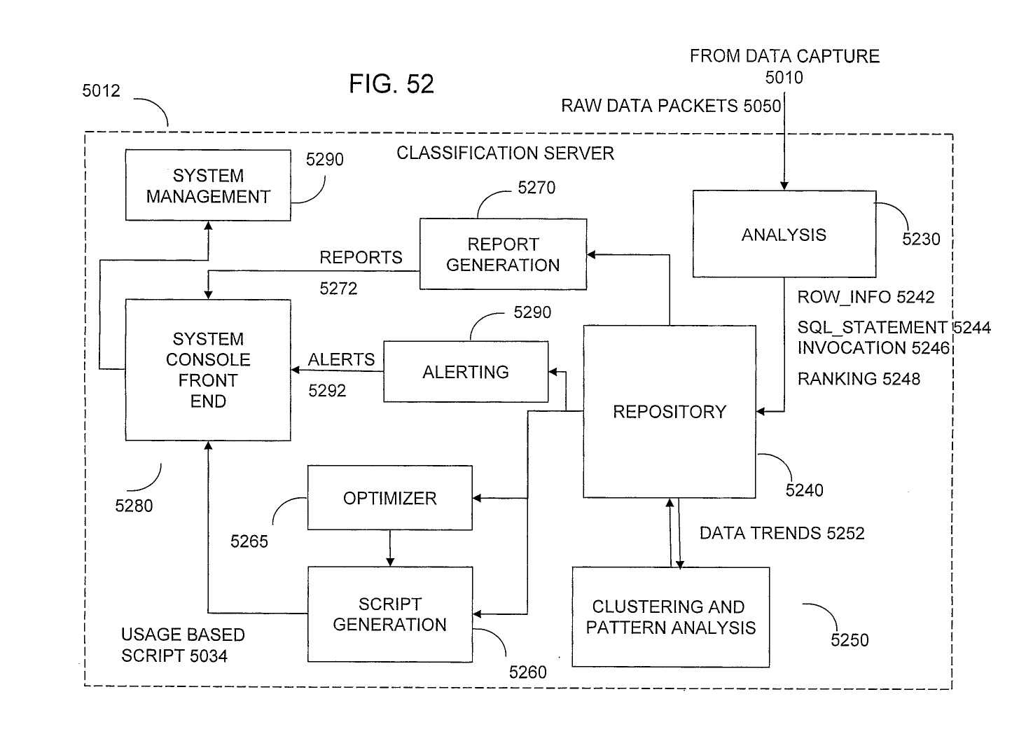

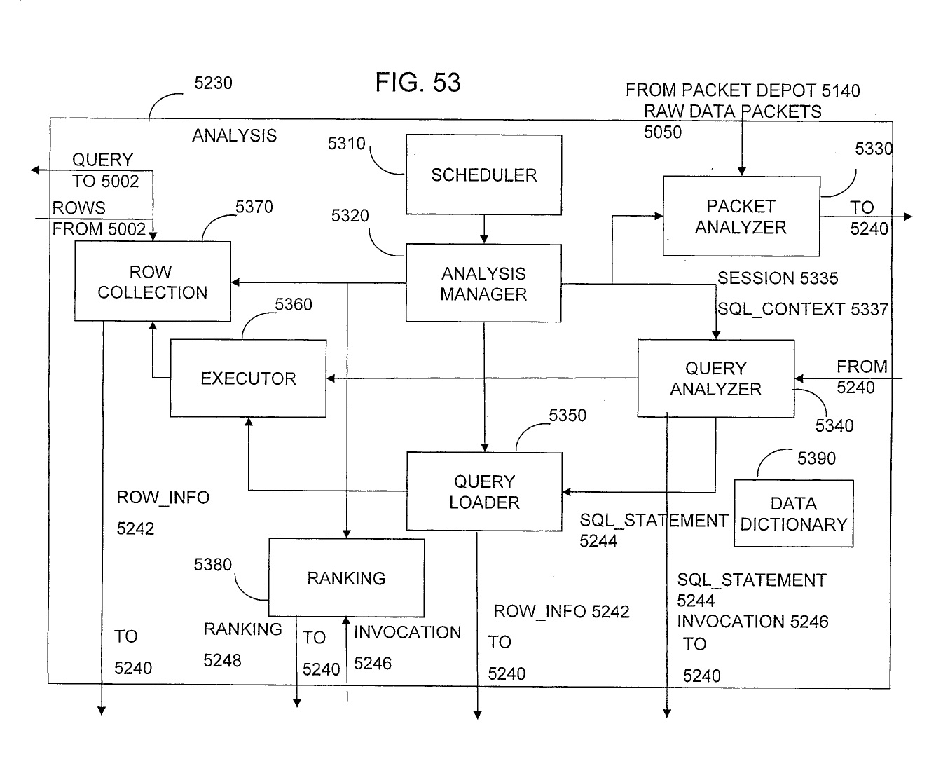

FIG. 50 is a simplified functional block diagram of a data table management system constructed and operative in accordance with an embodiment of the present invention. FIG. 51 is a simplified functional block diagram of data storage unit 5000 and data capture unit 5010 of FIG. 50, both constructed and operative in accordance with an embodiment of the present invention. FIG. 52 is a simplified functional block diagram of classification server 5020 of FIG. 50, constructed and operative in accordance with an embodiment of the present invention. FIG. 53 is a simplified functional block diagram of analysis unit 5330 of FIG. 52, constructed and operative in accordance with an embodiment of the present invention. In FIG. 50, classification server 5012 is operative to provide usage based data element rankings 5032, and usage based script 5034, to data usage-based table manager 5030. In FIG. 51, IP packets 5220 and 5222 preferably comprise database query request, response, and session control messages. IP stack filter 5116 provides filtered IP packets 5120 and 5122 to sniffer 5130. In FIG. 53, packet analyzer 5330 receives raw data packets from packet depot 5140.

FIG. 50 is a simplified Block Diagram of a Data Table Management System constructed and operative in accordance with a preferred embodiment of the present invention. The Data Storage element, 5002, represents the target system, comprising a data storage system including at least one data table. Data Storage System 5002 provides data services to applications, including transactional storage of large amounts of data, data warehousing, retrieval of one or more data elements from one or more tables based on a query language, for example, Structured Query Language (SQL-92, ISO/IEC 9075), and update and insertion of data elements based on criteria expressed in a Structured Query Language. The Data Storage System supports concurrent distributed access over a data communications network.

Typical applications which use the Data Storage System are shown as Application Users 5004, 5006 and 5008, which are examples of concurrent distributed data storage application users. These Application Users may send query requests 5014, 5018 and 5022 to the Data Storage System 5002, for example, over a distributed network. The queries may be queries for data retrieval, update, insertion as well as session establishment and control requests. The Data storage element returns query responses, for example, over a distributed network, as responses 5016, 5018 and 5024. The responses may comprise a collection of data records that satisfy the query request, as well as responses to session requests.

The Data Capture unit 5010 monitors the communications between the Application Users and the Data Storage System, and records the communications between the Data Storage System and the Application Users which are relevant to the Query Requests 5014, 5018, 5022 and to the respective query responses 5016, 5018 and 5024. The Data Capture unit records the communications as data packets, along with Session Control information as Raw Data Packets 5050. A preferred embodiment of The Data Capture unit and its interaction with other units is described with reference to FIG. 51.

The Classification Server 5012 reads the Raw Data Packets 5050. A preferred embodiment of the Classification Server is described in detail in FIG. 52. The Classification Server assembles a logical representation of the query and response from the Raw Data Packets, determining the individual data elements in the response, for example, the table row and columns, and records the usage information for each such element. The Classification Server may compute the Ranking of each such element and of the higher-level containing elements, such as table, or storage elements, such as data partition, indicating the importance of the element based on usage and user-specified criteria.

Based on this ranking, the Classification Server 5012 may generate Data Storage scripts 5034 which optimize the management of the Data Storage System 5002. Examples of these scripts include scripts for Data Partitioning, Data Copying, Data Cleansing and Data Mirroring, based on usage-based optimization. These scripts may be used by a Data Usage-based Management Processor 5030, which executes the management scripts through Data Management Commands 5036 sent to the Data Storage System 5002.

FIG. 51 is a simplified functional block diagram of Data Storage unit 5002 and Data Capture unit 5010 constructed arid operative in accordance with a preferred embodiment of the present invention. FIG. 51 describes architectural components which may be involved in the data usage recording process. An Application User 5004 sends Query Requests 5014 to the Data Storage unit 5002, and receives Query Responses 5016 in the course of the application use with the Data Storage unit, as described e.g. in FIG. 50.

Preferred data communications between the Application User and the Data Storage unit are shown. In a preferred embodiment, the Application User interacts with the Data Storage unit over a distributed network. A typical distributed network in a preferred embodiment is an Internet Protocol (IP) based packet network. Such a network is based on a set of layers of networking protocols, which implement the functionality of the multiple network layers. These layers are defined in the Open Systems Interconnect Model (OSI), which is specified by the ISO/IEC 7498-1 Standard, e.g. as described in Hubert Zimmermann, IEEE Transactions on Communications, vol. 28, no. 4, April 1980, pp. 425-432.

In a typical implementation of the network, each element uses a stack, which implements the set of protocols in layers. The data communications between an Application User such as user 5004 and a Data Storage unit such as unit 5002 typically uses a high level data base protocol at level 6, built on top of TCP/IP at level 4 and the underlying IP protocols and ancillary protocols such as DNS. This protocol stack is typically provided by an operating system which may be used on each network system, such as on the Data Storage unit. The data communications between the Application User and the Data Storage unit are transmitted over the IP-based network as a layered set of request IP packets 5220, and handled by the Operating System IP Stack 5210.

Typically, the Database Listener 5214 receives the initial set of IP packets for the Application User session establishment requests, and assigns a Database Server Process 5215 to handle further Application User requests. The responses as sent as IP packets 5222 through the Operating System IP Stack and over the network as the Query Response 5016 to the Application User. Subsequent Query requests are handled in the Data Storage unit by the Database Server Process 5215. An IP Stack Filter 5216 is used to intercept the flow of IP packets in the Operating System IP Stack, and to forward a copy of relevant request IP packets 5220 and response IP packets 5222 to the Data Capture unit 5010.

In the Data Capture unit 5010, the IP Packets 5220 and 5222 may be received by the Sniffer 5230 and assembled as Raw Data Packets 5050. The Sniffer may add context information such as a time stamp, user ID, application name and source and destination addresses to the request and response packets. A typical structure of the Raw Data Packets is described in Tables 1-5 herein. A typical state model of the Sniffer is illustrated in the state diagram of FIG. 34.

Typically, the Sniffer sends the Raw Data Packets 5050 to the Packet Depot 5240. The Packet Depot stores the Raw Data Packets for further analysis by the Classification Server 5012. A state model of the Packet Depot is illustrated in the state diagrams in FIGS. 35 and 36. A preferred process of recording of Query Requests and Query Responses between the Application User and the Data Storage unit by the Data Capture unit is described in FIGS. 2A-2B, for request recording, and in FIGS. 3A-3B for response recording. The collaboration diagram of FIG. 33 describes an architectural view of the recording of Query Requests and Query Responses in a preferred embodiment. This architecture is shown in the collaboration diagram of FIG. 37. The architecture of a preferred embodiment which enables recording of data communications for local clients to the Data Storage unit is shown in FIG. 38.

FIG. 52 is a simplified functional block diagram of Classification Server 5012. The Classification Server typically comprises an Analysis unit 5230, Repository 5240, Clustering and Pattern Analysis unit 5250, Report Generation unit 5270, Alerting unit 5290, Optimizer unit 5265, Script Generation unit 5260, System Console Front End 5280 and System Management unit 5290. The Analysis unit is responsible for processing the Raw Data Packets 5050 from the Data Capture unit 5010, analyzing the queries and assessing the data usage for each Data Storage element, for example, each table row and column. The analysis builds the SQL_Statement data structure 5244, which represents the structure of the Query Request, its invocations and parameters such as bind variables in the case of a SQL embodiment. A preferred structure of the SQL_Statement is described in Table 9. This structure may be stored in the Repository 5240.

Typically, the Analysis unit builds the ROW_Info data structure 5242, which represents the recorded details for a specific Data Storage element. A preferred data structure for this element is presented in Table 8. The Analysis unit records each Invocation 5246 of a query request that results in a Data Storage element being returned in the response. The list of Invocations 5246 for each SQL_Statement 5244 may be stored in the Repository 5240. The Analysis produces a Ranking 5248 for each Data Storage element, and maintains the Ranking in Repository 5240. A preferred embodiment of the Analysis unit is described in detail in FIG. 53. The Repository 5240 is the unit of the Classification Server which stores and maintains all of the data structures produced by the Classification Server.

Preferably, the Clustering and Pattern Analysis unit 5250 uses the ROW_Info, SQL_statement and Invocation data to identify field values of the ROW_Info that may be predictive of usage. The results may be expressed as trends for the ROW_Info and stored in Repository 5240.

The Script Generation unit 5260 produces usage-based scripts 5034 which enable usage-based management of the Data Storage unit 5002. The production of the scripts in accordance with a preferred embodiment is described in FIGS. 22A-B. Applications of the Script Generation unit with the Optimizer unit 5265 to Data Partitioning, Query Rerouting, ETL, Data Restoration, Data Mirroring and Data Cleansing are shown in FIGS. 23-30. Similar scripts can be produced for Data Copying. In the case of Data Copying, the scripts build a sequence of commands for copying data elements based on the usage and importance of the data elements.

Typically, the Report Generation unit 5270 produces reports 5172 which describe the usage of the Data in the Data Storage unit, based on the data structures produced by the Analysis unit 5230 and stored in the Repository 5240. The Reports 5272 provide views of the usage according to the importance ranking of the element types. The user views the Reports using the System Console and Front End 5280. FIGS. 18 and 19 illustrate report generation based on the analysis results. Report generation according to Method H is shown in the collaboration diagram in FIG. 47.

The Alerting unit 5290 may provide Alerts 5292 to notify users of operational issues, errors and faults, as illustrated in FIGS. 20A-B. The Alerting provides notification to the user of specific conditions in data usage in the Data Storage unit as illustrated in FIGS. 21A-B.

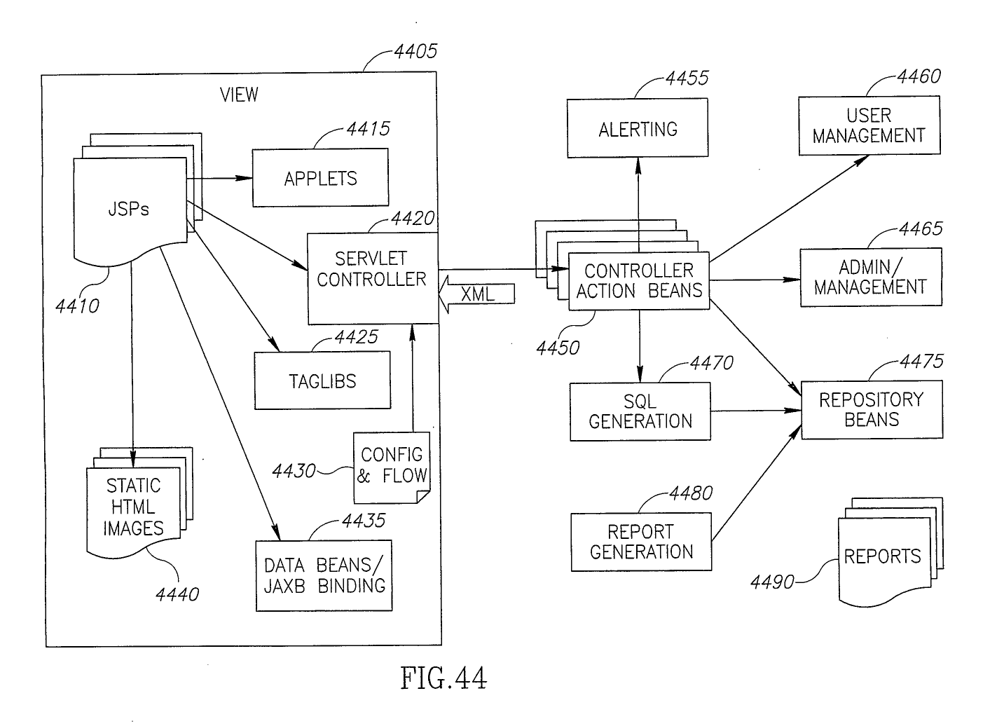

Typically, the System Console and Front End 5280 provides the user with a Graphical User Interface (GUI) for viewing Reports 5272, configuring the Data Capture 5010, configuring the Analysis 5130, configuring the Clustering and Pattern Analysis 5250, configuring the Report Generation 5270, configuring the Alerting 5290 and configuring the Script Generation 5260. The System Console and Front End displays Alters 5292 to the user. The System Console and Front End allow the user to control the System Management unit 5290. FIG. 44 describes an architecture for a preferred embodiment of the System Console and Front End, and the interface to the components of the Classification Server. The collaboration diagram in FIG. 45 describes the implementation of the System Console and Front end using the Java 2 Enterprise Edition (J2EE) framework for a preferred embodiment. Report display in the System Console and Front End according to Method G is shown in the sequence diagram in FIG. 46.

FIG. 53 is a simplified functional block diagram of Analysis unit 5230 of the Classification Server 5012. Typically, the Analysis unit processes the recorded Raw Data Packets 5260, builds data structures to represent the Data element usage of the Data Storage unit, and assigns Ranking to each element. The high-level processing of the Analysis unit according to a preferred embodiment of the present invention is shown in the schematic diagram of FIG. 40, and in the activity diagram in FIG. 43. The core data structures that may be built by the Analysis unit 5230, SQL_Statement 5244, Invocation 5246, ROW_Info 5246, Ranking 5248 and SQL_Parsed are described, and their relationships shown, in the class diagram of FIG. 32.

Typically, an additional element, the Initial Rank Builder, creates the initial ranking for a Data Storage unit before recorded usage data is available. The Initial Rank Builder may build the ranking using the method described in Method A, and is described in the collaboration diagram in FIG. 41.

Typically, the Analysis unit comprises a Scheduler 5310, Analysis Manager 5320, Packet Analyzer 5330, Query Analyzer 5340, Query Loader 5350, Executor 5360, Row Collection 5370 and Data Dictionary 5390. The Analysis unit uses the Repository 5140 for storage and retrieval of data structures, and accesses the Data Storage 5002 for queries of the Data elements. The Scheduler 5310 triggers the running of Analysis according to a pre-defined schedule. The Scheduler invokes the Analysis Manager 5320 according to the analysis schedule as shown in FIGS. 4A-4B.

Typically, the Analysis Manager 5320 coordinates the invocation and processing of the Analysis components. The Analysis Manager invokes the Packet Analyzer 5330 as shown in the flow diagram in FIGS. 4A-B. After processing of all of the Sessions in the Raw Data Packets 5260, the Analysis Manager invokes the Query Analyzer 5340 as shown in the flow diagram in FIG. 7. The Analysis Manager invokes the Query Loader as shown in the flow diagram in FIGS. 10A-B, to process queries queued by the Query Analyzer. The Analysis Manager invokes the Executor 5360 to process Data element queries to the Data Storage unit as shown in FIG. 12. The Analysis Manager invokes the Row Collection unit 5370 to process the Data element query results of the Executor as shown in FIG. 14. The Analysis Manager reports status to the System Console and Front End 5280 through a method described in Method I. This functionality of the Analysis Manager is shown in the collaboration diagram in FIG. 48.

Typically, the Packet Analyzer 5330 processes the Raw Data Packets 5260. The unit reconstructs the user Session and the logical structure of the Query Request 5014 and Query Response 5106 from the Raw Data Packets. The Packet Analyzer builds the data structures for the Session 5335 shown in Table 6 and the SQL_Context 5337 shown in Table 7, using a method described in Method B. The processing of the Packet Analyzer is described in FIGS. 5A-6B, and in the collaboration diagram in FIG. 42. The relationship between the Session and SQL_Context data structures is shown in the class diagram in FIG. 31.

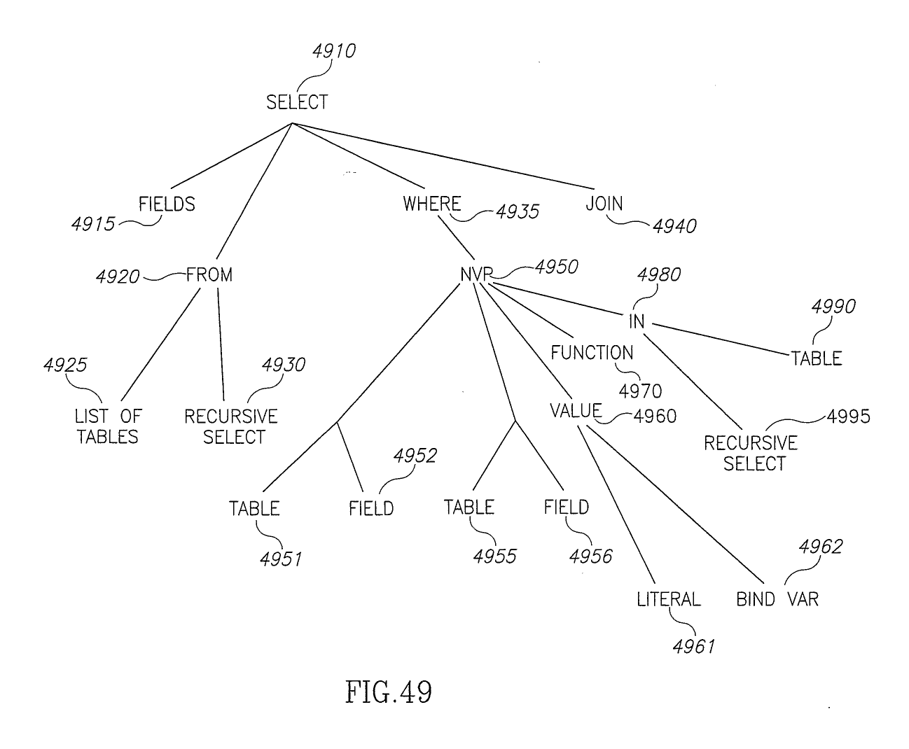

Typically, the Query Analyzer 5340, also termed herein the “SQL analyzer”, processes the results of the Packet Analyzer. The Query Analyzer preferably identifies the Query Request as a logical query statement so as to build full data structures for usage analysis. The Query Analyzer processing is described in FIGS. 8A-9B. The Query Analyzer builds the data structures for Invocations 5346, SQL_Statement 5344 which is shown in Table 9. The SQL_Statement has a reference to the parsed query representation in the SQL_Parsed_Table described in Table 10. The parse tree for the SQL_Statement is shown in FIG. 49. The Query Analyzer prepares requests for the Query Loader 5350 for resolution of unique Data elements where the Query Response contains a unique Data element identifier such as a primary key. The Query Analyzer prepares requests for the Executor 5360 for identification of unique Data elements where the Query Response does not uniquely identify the Data elements. The method used by the Query Analyzer is described in Method C.

Typically, the Query Loader 5350 processes the requests from the Query Analyzer for identification of response records. The Query Loader may uniquely identify every Data elements referred to in the Query Response which contains a unique identifier in the response record. These records in the Query Response are referred to as Response Records in FIG. 40. The processing of the Query Loader is shown in the flow diagrams in FIGS. 11A-B. The Query Loader builds the Row_Info 5342 data structure which is shown in Table 8. The method used by the Query Loader may be Method D described herein.

The Executor 5360 may process the requests from the Query Analyzer for identification of response records. The Executor typically uniquely identifies every Data element referred to in the Query Response which does not otherwise have any unique identifier in the response records such as a primary key or unique key. The Executor uses the SQL_Statement and, through the Data Storage schema represented in the Data Dictionary 5390, constructs a query to the Data Storage unit to identify the Data element. The processing of the Executor is shown in FIGS. 13A-13B. The Executor queues the queries to the Row Collection unit for processing. The method used by the Executor may be Method E.

Typically, the Row Collection unit 5370 evaluates the query requests sent by the Executor on the Data Storage unit 5002. The Row Collection unit uses the responses from the Data Storage unit to build the Row_Info 5342 data structure which is shown in Table 8. The processing of the Row Collection unit is shown in FIGS. 15A-B. The method used by the Row Collection unit may be Method F.

Typically, the Ranking unit 5380 computes the Ranking 5348 for the Data elements represented in the Repository 5140. The ranking computation is based on Data element usage, as defined as a function of the Invocation records, and is configured by the user, including the user-defined weighting of importance of data or user applications. The processing of the Ranking unit is shown in FIGS. 16 and 17. Ranking is computed at the Data element level. In the case of a Relational Database, this is at the level of rows. Ranks are also computed as a composite, at the level of Table and Partition. Additionally, Ranks are computed for Table Columns and for Queries. The Data Dictionary 5390 provides an interface for the schema, meta-data and Data element statistics of the Data Storage unit 5003.

According to one embodiment of the invention, the system may comprise one or more computers or other programmable devices, programmed in accordance with some or all of the apparatus, methods, features and functionalities shown and described herein. Alternatively or in addition, the apparatus of the present invention may comprise a memory which may be readable by a machine and which contains, stores or otherwise embodies a program of instructions which, when executed by the machine, comprises an implementation of some or all of the apparatus, methods, features and functionalities shown and described herein. Alternatively or in addition, the apparatus of the present invention may comprise a computer program implementing some or all of the apparatus, methods, features and functionalities shown and described herein and being readable by a computer for performing some or all of the methods of, and/or implementing some or all of the systems of, embodiments of the invention as described herein.

It is appreciated that software components of the present invention may, if desired, by implemented in ROM (read only memory) form. The software components may, generally, be implemented in hardware, if desired, using conventional techniques.

Features of the present invention which are described in the context of separate embodiments may also be provided in combination in a single embodiment. Conversely, features of the invention which are described for brevity in the context of a single embodiment may be provided separately or in any suitable subcombination.

1. A data table management system operative to manage at least one data table storing a multiplicity of data elements, the system comprising: a data element usage monitor operative to record information pertaining to usage of individual elements in said at least one data table; and a data element evaluator operative to evaluate the importance of data elements as a function of said information pertaining to usage thereof recorded by said data element usage monitor.

2. A system according to claim 1 wherein said data element usage monitor comprises a time stamper operative to record temporal information pertaining to usage of individual elements in said at least one data table.

3. A system according to claim 1 wherein said data element usage monitor comprises a user ID recorder operative to record information pertaining to the identities of users of individual data elements in said at least one data table.

4. Data repository apparatus operative in conjunction with at least one data table storing a multiplicity of data elements, the data repository apparatus comprising: a representation of information pertaining to usage of individual elements in said at least one data table.

5. A system according to claim 1 and also comprising a data partitioner operative to partition said at least one data table at least partly based on said information recorded by said data element usage monitor.

6. A system according to claim 1 and also comprising a data table copier operative to copy at least a portion of at least one data table managed by said data table management system in an order determined by said data element evaluator.

7. A system according to claim 6 wherein said data table comprises a multiplicity of rows of data and wherein said order comprises a ranking of said rows.

8. A system according to claim 6 wherein said data table comprises a plurality of partitions of data and wherein said order comprises a ranking of said partitions.

9. A system according to claim 6 wherein said data table comprises a plurality of columns of data and wherein said order comprises a ranking of said columns.

10. A system according to claim 6 wherein said data table managed by said system comprises a back-up version of another data table.

11. A data table management method for managing at least one data table, the method comprising: recording information pertaining to usage of individual elements in said at least one data table; and evaluating the importance of data elements as a function of said information pertaining to usage thereof recorded by said data element usage monitor.

12. A method according to claim 11 and also comprising copying at least at portion of at least one data table managed by said data table management system in an order determined by said evaluating step.

13. A method according to claim 12 wherein said copying step comprises copying said at least one data table into a data warehouse.

14. A method according to claim 12 wherein said copying step comprises copying said at least one data table into a data mart.

15. A method according to claim 13 and wherein said copying step comprises extracting, transforming and loading said at least one data table into said data warehouse.

16. A method according to claim 14 and wherein said copying step comprises extracting, transforming and loading said at least one data table into said data mart.

17. A system according to claim 6 and also comprising a data copier operative to copy a portion of at least one data table managed by said data table management system, wherein said portion is selected at least partly as a function of the importance of the data elements as evaluated by said data element evaluator.

18. A system according to claim 1 and also comprising a data table partitioner operative to partition at least a portion of at least one data table in accordance with a partitioning criterion determined at least partly as a function of the importance of the data elements as evaluated by said data element evaluator.

19. A system according to claim 1 and also comprising a data tiering functionality operative to allocate data within said at least one data table to a plurality of storage media in accordance with a tiering criterion determined at least partly as a function of the importance of the data elements as evaluated by said data element evaluator.

20. A method according to claim 1 and also comprising allocating data within said at least one data table to a plurality of storage media in accordance with a tiering criterion determined at least partly as a function of the importance of the data elements as evaluated by said data element evaluator.

21. A method according to claim 20 and also comprising repeating said evaluating and allocating steps so as to redistribute said data among said plurality of storage media as a function of a more current evaluation of the importance of the data in said at least one data tables.

22. A system according to claim 1 and also comprising a data table storing an incoming flow of data elements.

23. A system according to claim 1 wherein said information pertaining to usage of individual elements comprises at least one of the following types of information: information pertaining to usage of individual rows; information pertaining to usage of individual columns; information pertaining to usage of individual partitions; information pertaining to usage of individual cells; information pertaining to usage of individual indices.

24. A method according to claim 20 wherein said tiering criterion is at least partly a function of cost of storage and management of each of said plurality of storage media.

25. A system according to claim 1 and also comprising a data cleansing functionality operative to cleanse data within said at least one data table in accordance with a cleansing prioritizing order determined at least partly as a function of the importance of the data elements as evaluated by said data element evaluator.

26. A system according to claim 1 and also comprising a partial mirroring functionality operative to generate a copy of a subset of said multiplicity of data within said at least one data table wherein said subset is selected at least partly as a function of the importance of the data elements as evaluated by said data element evaluator.

27. A system according to claim 26 and wherein said partial mirroring functionality is operative to maintain the copy of a subset of said multiplicity of data wherein said subset is repeatedly selected at least partly as a function of the current importance of the data elements as periodically evaluated by said data element evaluator.

28. A method according to claim 11 and also comprising: separating said at least one data table into a plurality of smaller data tables, using a separation criterion to allocate data elements to an individual one of said smaller tables which is at least partly determined as a function of said importance of said data elements as evaluated by said data element usage monitor; capturing a query in real time and determining which of the plurality of smaller data tables it pertains to; and routing said query only to those of the plurality of smaller data tables to which it pertains.

29. A system according to claim 1 wherein said data element usage monitor is operative to analyze a population of queries and determine, for each query, identities of data elements accessed responsive to said query.

30. A system according to claim 1 wherein said data element usage monitor is operative to analyze a population of query responses and determine, for each query response, identities of data elements accessed in order to generate said query response.

31. A system according to claim 29 wherein said data element usage monitor is also operative to analyze a population of query responses and to match them to said population of queries.

32. A system according to claim 1 and also comprising a query-response table generator operative to store each response to a query directed at said at least one data table, each in association with its respective query.

33. A query-response retaining system, operative in conjunction with database apparatus comprising at least one data table storing a multiplicity of data elements and a query handler operative to receive queries pertaining to at least one of said multiplicity of data elements, the system comprising: a query-response retainer operative to store each response to a query directed at said at least one data table, each in association with its respective query.

34. A system according to claim 33 wherein said query-response retainer is operative to capture, in real time, each query directed at said database apparatus.

35. A system according to claim 33 wherein said query-response retainer is operative to capture, in real time, each query response generated by said database apparatus.

36. A system according to claim 33 wherein said query-response retainer is operative to match each response to its corresponding query.

37. A system according to claim 33 and also comprising an auditor operative to analyze said stored queries and responses.

38. A system according to claim 37 wherein said auditor performs at least one of the following operations: identifying which data was returned to which user; identifying time at which data was returned; identifying locations from which queries were made; and identifying locations to which responses were sent.

39. A system according to claim 2 wherein said data element usage monitor comprises a user ID recorder operative to record information pertaining to the identities of users of individual data elements in said at least one data table.
